(19) United States
(12) Patent Application Publication
(10) Pub. No.: US 2026/0180648 A1
(43) Pub. Date: Jun. 25, 2026

(54) METHODS AND PROCEDURES FOR CSI DETERMINATION BASED ON MEASUREMENT RESOURCES AT DIFFERENT POWER LEVELS

(71) Applicant: InterDigital Patent Holdings, Inc., Wilmington, DE (US)

(72) Inventors: Mohammad Irfan, Chateauguay (CA); Loic Canonne-Velasquez, Dorval (CA); Afshin Haghighat, Ile-Bizard (CA); Moon IL Lee, Melville, NY (US); Omid Saatlou, Montreal (CA)

(73) Assignee: InterDigital Patent Holdings, Inc., Wilmington, DE (US)

(21) Appl. No.: 18/989,371

(22) Filed: Dec. 20, 2024

(51) Int. Cl. H04B 7/06; H04B 17/318; H04W 52/24

(52) U.S. Cl. CPC H04B 7/0626; H04B 17/318; H04W 52/245

(57) ABSTRACT

A wireless transmit/receive unit (WTRU) may receive configuration information. The configuration information may be associated with one or more channel state information (CSI) reference signals (RS). The WTRU may receive a first indication of a first transmit power level and/or a second indication of a second transmit power level. The first transmit power level comprises an energy per resource element (EPRE) associated with a CSI-RS resource (RE) and the second transmit power level comprises a hypothetical physical downlink shared channel (PDSCH) (EPRE) associated with the CSI-RS resource. The WTRU may determine whether the second transmit power level is the same for the one or more CSI RS. The WTRU may determine compensation factor to determine CSI. The WTRU send an indication of determined CSI to a network.

### BACKGROUND

In the existing CSI framework, a base station (BS and/or gNB) may configure measurement resources, for example channel state information (CSI) reference signal (RS) (CSI-RS), for CSI measurement. The configuration may include indications that a wireless transmit/receive unit (WTRU) may use for determining, calculating, and/or predicting a CSI based on the received CSI-RS resources. For example, the WTRU may receive a configuration of a CSI-RS resource in a CSI-RS resource set. The CSI-RS resource set may include one or more CSI-RS resources, for example where each CSI-RS resource may include an associated indication of a power level of the CSI-RS resource in reference to a physical broadcast channel (PBCH). For example the indication of the power level of the CSI-RS resource may include an indication of powerControlOffsetss, which may include a ratio of the energy per resource element (EPRE) of the physical broadcast channel (PBCH) to the EPRE of the CSI-RS resource.

### SUMMARY

A WTRU may receive configuration information. The configuration information may be associated with one or more CSI-RS. The configuration information may include a first indication of a first transmit power level and/or a second indication of a second transmit power level. The first transmit power level may include an energy per resource element (EPRE) associated with a CSI-RS resource (RE) and the second transmit power level may include a hypothetical physical downlink shared channel (PDSCH) (EPRE) associated with the CSI-RS resource. The WTRU may determine whether the second transmit power level is the same for each of the one or more CSI RS. The WTRU may determine compensation factor to determine CSI. The WTRU send an indication of determined CSI to a network.

The WTRU may determine a third transmit power level. The WTRU may determine compensation factor to determine CSI based on the third transmit power level. The WTRU may receive a third indication. The third indication may indicate one or more of a correction factor and/or a selection indicator. The WTRU may determine the third transmit power level based on the correction factor and/or the selection indicator. The selection indicator may indicate the first transmit power level or the second transmit power level. For example, the WTRU may determine that the third transmit power level equals the second transmit power level plus the correction factor when the selection indicator indicates the second transmit power level.

The WTRU may determine the CSI based on a hypothetical downlink transmit power level equal to the third transmit power level. The WTRU may determine whether the first transmit power level is the same for the one or more CSI RS, for example based on a determination that the second transmit power level is the same for the one or more CSI RS. The WTRU may determine the CSI without compensation factor, for example based on a determination that the first transmit power level is the same for the one or more CSI RS. The compensation factor may include a matrix. The WTRU may determine the matrix. For example, the WTRU may determine compensation factor to determine CSI based on the matrix. The WTRU may determine compensation factor to determine CSI based on the first transmit power level.

The WTRU may receive configuration information associated with a plurality of sets of CSI-RSs. The configuration information may include a first indication of a first transmit power level and a second indication of a second transmit power level for each of the one or more sets of CSI-RSs. The WTRU may determine whether a third power level for at least one of the sets of the CSI-RSs based on whether the second transmit power level is the same for each of the sets of CSI-RSs. The WTRU may determine whether to apply a compensation factor for the at least one of the sets of CSI-RSs based on whether the first transmit power level is the same for each of the sets of CSI-RSs.

The WTRU may determine a CSI value based on the at least one set of the sets of CSI-RSs and one or more of the third power level or the compensation factor. The WTRU may report the CSI to a network. The first power level may correspond to an energy per resource element (EPRE). The second power level may correspond to a hypothetical physical downlink shared channel (PDSCH) EPRE. The third power level may correspond to the second power level with an applied correction factor. The compensation factor may correspond to a scaling factor associated with a precoder or a channel estimate.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example graph of CSI-RS reception, CSI determination, and CSI reporting based on a CSI timeline.

FIG. 3 is another example graph of CSI-RS reception, CSI determination, and CSI reporting based on a CSI timeline.

FIG. 4 is a flowchart of an example procedure of a WTRU for CSI determination.

### DETAILED DESCRIPTION

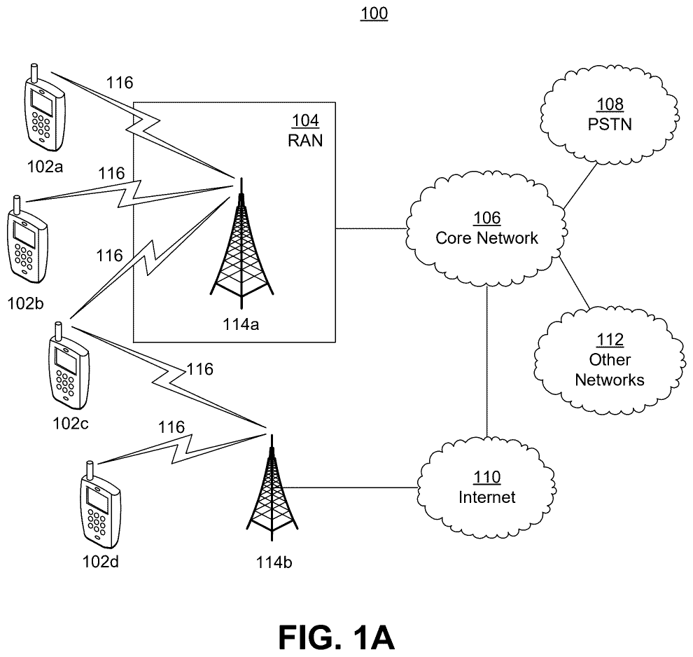

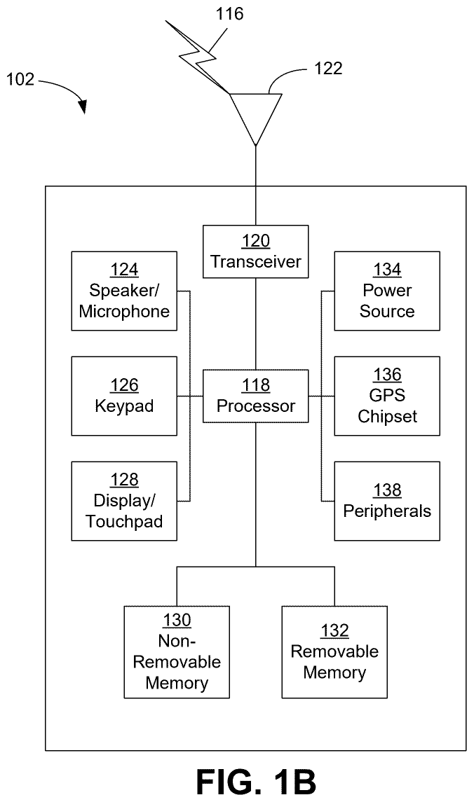

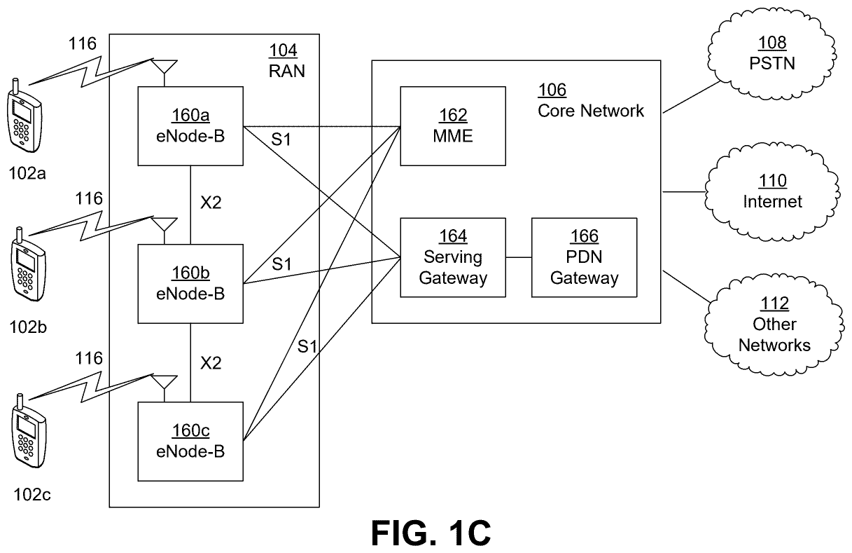

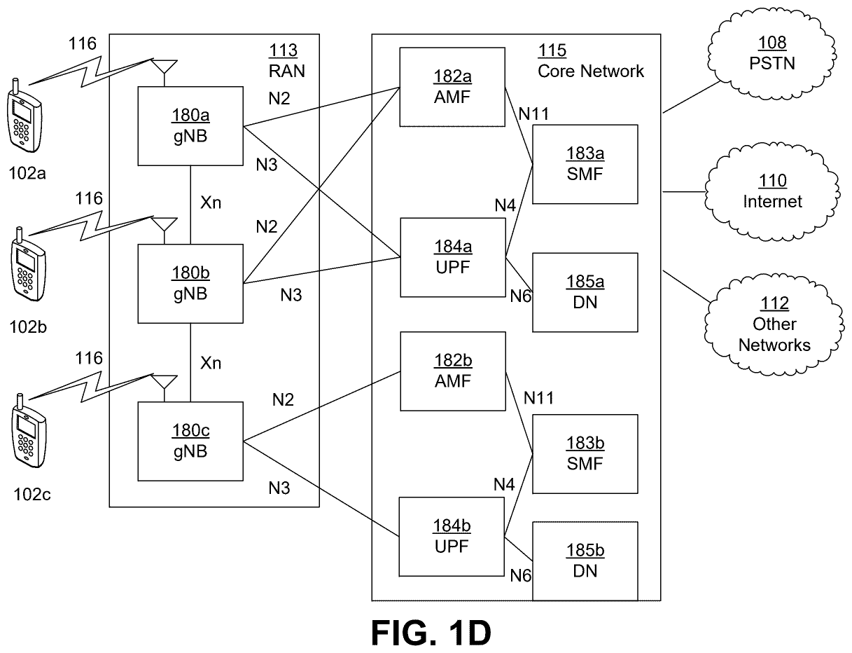

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A CSI-RS resource may include an associated indication of a power level of a hypothetical physical downlink shared channel (PDSCH), for example with reference to the power level of the CSI-RS (e.g, powerControlOffset). The powerControlOffset may include a ratio of the energy per resource element (RE) (EPRE) of the hypothetical PDSCH to the EPRE of the CSI-RS resource. For example powerControlOffsetss and powerControlOffset may be determined by:

$$powerControlOffsetss = \frac{EPRE of PBCH}{EPRE of CSI - RS}$$

$$powerControlOffset = \frac{EPRE of hyp othetical PDSCH}{EPRE of CSI - RS}$$

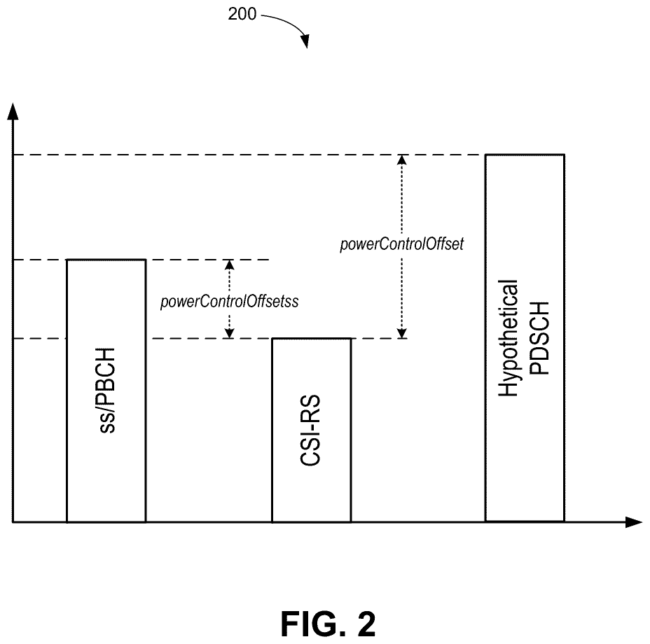

FIG. 2 is an example graph 200 of CSI-RS reception, CSI determination, and CSI reporting based on a CSI timeline. Based on the powerControlOffsetss value for example, the WTRU may determine the power level of the CSI-RS resource. Based on the powerControlOffset value for example, the WTRU may determine (e.g., assume) a power level of the hypothetical PDSCH for determination of a CSI. For example, the CSI-RS power level may be balanced (e.g., there is one CSI-RS power level).

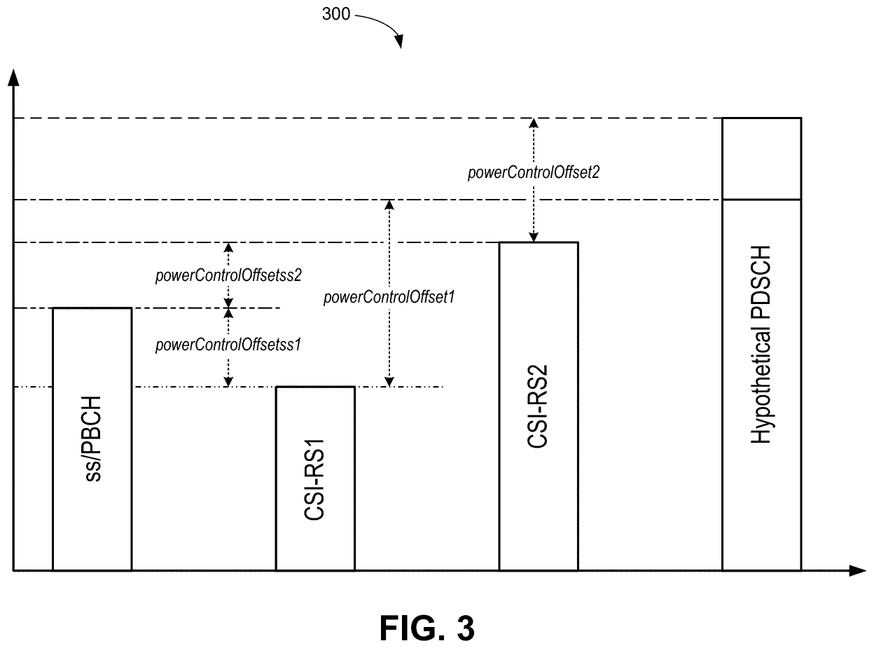

FIG. 3 is another example graph 300 of CSI-RS reception, CSI determination, and CSI reporting based on a CSI timeline. Based on the powerControlOffsetss 1 value for example, the WTRU may determine the power level of the CSI-RS1 resource. Based on the powerControlOffset1 value for example, the WTRU may determine (e.g., assume) a power level of the hypothetical PDSCH for determination of a CSI. Based on the powerControlOffsetss2 value for example, the WTRU may determine the power level of the CSI-RS2 resource. Based on the powerControlOffset2 value for example, the WTRU may determine (e.g., assume) a power level of the hypothetical PDSCH for determination of a CSI. For example, the CSI-RS power level may be imbalanced (e.g., there are different CSI-RS power levels CSI-RS1 and CSI-RS2).

A base station (e.g., gNB) may use or share a CSI-RS resource for more than one WTRU, for example to reduce CSI-RS overhead. The existing specifications requires balanced power setting for CSI determination. For example, a predicted precoding matrix indicator (PMI)/CSI or high Doppler PMI/CSI may utilize a plurality of CSI-RSs (e.g., a burst of CSI-RS resources for measurement of CSI). Each CSI-RS resource in the burst of CSI-RS resources may include the same powerControlOffset value and/or the same powerControlOffsetss value. For example, CSI-RS resources may be configured with a balanced power setting. In some examples up to 32 CSI-RS antenna ports may be supported. In other examples up to 128 CSI-RS antenna ports may be supported. To support up 64 CSI-RS antenna ports for example, the CSI-RS antenna ports may be aggregated across multiple CSI-RS resources. The 64 CSI-RS antenna ports may be aggregated across 2 CSI-RS resources. For example, the first 32 (e.g., 1-32) CSI-RS antenna ports may be associated with the first CSI-RS resource and/or the second 32 (e.g., 33-64) CSI-RS antenna ports may be associated with the second CSI-RS resource. The CSI-RS resources (e.g., the first and second CSI-RS resources) may be configured with a balanced power setting.

The use of balanced power settings may restrict a gNB ability or choice of sharing or using the CSI-RS resources with other WTRUs, which for example may increase CSI-RS overhead. For example, a gNB may configure 2 CSI-RS resources, where each of the 32 CSI-RS antenna ports have an imbalanced power setting. The gNB may use the 2 CSI-RS resources for two WTRUs. Utilizing (e.g., requiring) balanced power setting may restrict the gNB to use the 2 CSI-RS resources, for example for a WTRU supporting 64 CSI-RS antenna ports.

When multiple CSI-RS resources are configured with an imbalanced power setting for example, the WTRU may make different assumptions for CSI calculation. Additionally, or alternatively, the WTRU may make different assumptions for CSI calculation due to the imbalanced power setting that for example may result in one or more of different CSI determination, estimation, and/or prediction. For example, the CSI-RS resource set may include 2 CSI-RS resources. The first CSI-RS resource may have an associated powerControlOffset1 value and/or the second CSI-RS resource may have an associated powerControlOffset2 value. The powerControlOffset1 and the powerControlOffset2 may indicate two different hypothetical PDSCH EPRE values, for example p₂₁ and p₂₂, respectively. When determining a CSI for example, the WTRU may consider (e.g., either) p₂₁ and/or p₂₂. CSI determined based on p₂₁ and p₂₂ may be different. For example, CSI determined based on p₂₁ may result in CQI1 and/or CSI determined based on p₂₂ may result in CQ12, where for example CQI1 is different from CQI2.

A CSI-RS resource set may have 2 CSI-RS resources. The first CSI-RS resource may have an associated powerControlOffsetss1 value and/or the second CSI-RS resource may have an associated powerControlOffsetss2 value. For example the two CSI-RS resources may be transmitted at different power levels (e.g., CSI-RS1 and CSI-RS2). The estimated channel matrix using the CSI-RS resources may (e.g., therefore) be scaled by different scaling factors (e.g., different power levels). The estimated channel (e.g., therefore) may not be an accurate estimate of the actual channel.

Problems when the CSI-RS resources are configured with imbalanced power setting for CSI determination may include problems with determination of a power level for a hypothetical PDSCH and/or problems with inaccurate estimation of a channel. For example determining a power level of the hypothetical PDSCH for one or more of determination, calculating and/or prediction of the CSI may be difficult, for example as different hypothetical PDSCH power levels may be assumed and/or considered based on indications associated with different CSI-RS resources in the CSI-RS resource set. Compensating the estimated CSI may be difficult, for example as an imbalanced power setting may cause inaccurate estimation of the actual channel.

Systems and methods are disclosed that include an explicit or implicit indication of a CSI-RS resource index in a CSI-RS resource set and/or other indications to the WTRU to determine a hypothetical PDSCH power level. The hypothetical PDSCH power level may be used, assumed, and/or considered by the WTRU during determination of a CSI report. Systems and methods are disclosed that include a precoder structure that compensates for the CSI at the precoder level, for example when the CSI-RS resources are configured with an imbalanced power setting. Systems and methods are disclosed that include that scale one or more of the power level(s), amplitude level(s), and/or eigen value(s) of a channel matrix, for example that is determined using the configured CSI-RS with an imbalanced power setting. The scaled channel matrix (e.g., then) may be used for determination of CSI.

Herein the terms, power, energy, and EPRE may be used interchangeably. The terms power setting and/or energy setting may refer to one or more of the power, energy, and/or EPRE of one or more CSI-RS resources in a CSI-RS resource set; the power, energy, and/or EPRE of a hypothetical PDSCH based on one or more CSI-RS resources; and/or the powerControloffset value and/or the powerControloffsetss value associated with one or more CSI-RS resources in a CSI-RS resource set. Herein the terms, balanced power and/or balanced power setting may refer to a case or condition where power levels of the CSI-RS resources in a CSI-RS resource set may be the same and/or the power levels of the hypothetical PDSCH(s) based on indications associated with the CSI-RS resources may be the same. For example, a CSI-RS resource set may include two CSI-RS resources. The power level of the first CSI-RS resource may be the same as the power level of the second CSI-RS resource and/or the power level of hypothetical PDSCH based on indication associated with the first CSI-RS resource and second CSI-RS resource may be the same. For example, a CSI-RS resource set may include two CSI-RS resources. The powerControloffsetss value associated with the first CSI-RS resource may be the same as the powerControloffsetss value associated with the second CSI-RS resource and/or the powerControlOffset value associated with the first CSI-RS resource may be the same as the powerControlOffset value associated with the second CSI-RS resource.

Herein the terms imbalanced power and/or imbalanced power settings may refer to one or more cases and/or conditions for example including one or more of power levels of the CSI-RS resources in a CSI-RS resource set may be the same and/or the power levels of the hypothetical PDSCH(s) based on indications associated with the CSI-RS resources may be different; power levels of the CSI-RS resources in a CSI-RS resource set may be different and/or the power levels of the hypothetical PDSCH(s) based on indications associated with the CSI-RS resources may be the same; and/or power levels of the CSI-RS resources in a CSI-RS resource set may be different and/or the power levels of the hypothetical PDSCH(s) based on indications associated with the CSI-RS resources may be different.

The power levels of the CSI-RS resources in a CSI-RS resource set may be the same and/or the power levels of the hypothetical PDSCH(s) based on indications associated with the CSI-RS resources may be different. For example, a CSI-RS resource set may include two CSI-RS resources. The power level of the first CSI-RS resource may be the same as the power level of the second CSI-RS resource and/or the power level of hypothetical PDSCH based on indication associated with the first CSI-RS resource may be different than the power level of hypothetical PDSCH based on indication associated with the second CSI-RS resource. For example, a CSI-RS resource set may include two CSI-RS resources. The powerControloffsetss value associated with the first CSI-RS resource may be the same as the powerControloffsetss value associated with the second CSI-RS resource and/or the powerControlOffset value associated with the first CSI-RS resource may be different than the powerControlOffset value associated with the second CSI-RS resource.

The power levels of the CSI-RS resources in a CSI-RS resource set may be different and/or the power levels of the hypothetical PDSCH(s) based on indications associated with the CSI-RS resources may be the same. For example, a CSI-RS resource set may include two CSI-RS resources. The power level of the first CSI-RS resource may be different than the power level of the second CSI-RS resource and/or the power level of hypothetical PDSCH based on indication associated with the first CSI-RS resource may be the same as the power level of hypothetical PDSCH based on indication associated with the second CSI-RS resource. For example, a CSI-RS resource set may include two CSI-RS resources. The powerControloffsetss value associated with the first CSI-RS resource may be different than the powerControloffsetss value associated with the second CSI-RS resource and/or the powerControlOffset value associated with the first CSI-RS resource may be the same as the powerControlOffset value associated with the second CSI-RS resource.

The power levels of the CSI-RS resources in a CSI-RS resource set may be different and/or the power levels of the hypothetical PDSCH(s) based on indications associated with the CSI-RS resources may (e.g., also) be different. For example, a CSI-RS resource set may include two CSI-RS resources. The power level of the first CSI-RS resource may be different than the power level of the second CSI-RS resource and/or the power level of hypothetical PDSCH based on indication associated with the first CSI-RS resource may be different than the power level of hypothetical PDSCH based on indication associated with the second CSI-RS resource. For example, a CSI-RS resource set may include two CSI-RS resources. The powerControloffsetss value associated with the first CSI-RS resource may be different than the powerControloffsetss value associated with the second CSI-RS resource and/or the powerControlOffset value associated with the first CSI-RS resource may be different than the powerControlOffset value associated with the second CSI-RS resource.

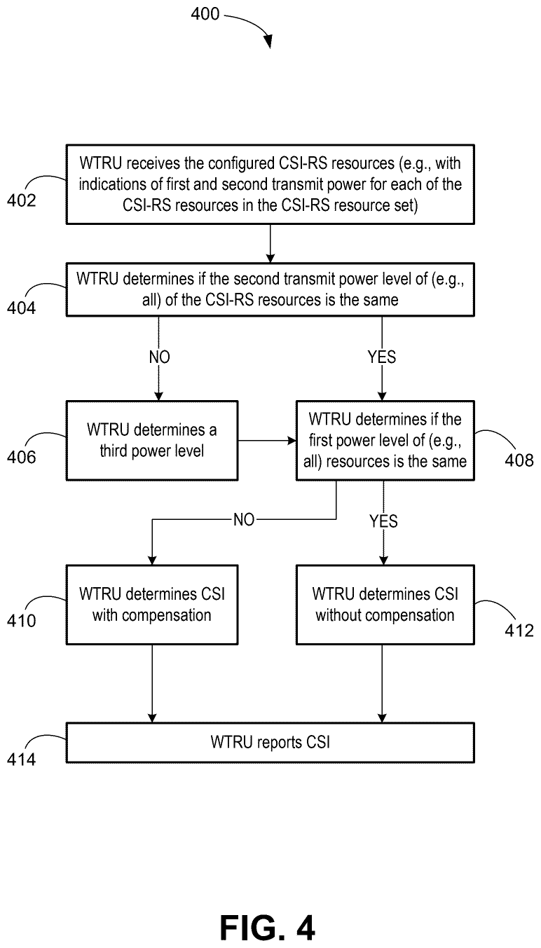

FIG. 4 is a flowchart of an example procedure of a WTRU for CSI determination. For example, the WTRU may implement the example procedure 400 for a balanced and/or imbalanced power setting. At 402 the WTRU may receive an indication of CSI-RS resources. For example, the WTRU may receive configuration information. The configuration information may include a CSI-RS resource configuration that may include a first set of indications. The indication of CSI-RE resources and/or the CSI-RS resource configuration information may include one or more of a number of CSI-RS resource set(s), a number of CSI-RS resource(s) in a CSI-RS resource set, and/or a number and indexes of CSI-RS antenna ports associated with the CSI-RS resource(s) in the CSI-RS resource set(s). The WTRU may receive the CSI-RS resources in a CSI-RS resource set(s).

One or more of the CSI-RS resources in a CSI-RS resource set may include an associated second set of indications. The second set of indication may indicate one or more of a first power level (e.g., EPRE of the CSI-RS resource), a second power level (e.g., hypothetical PDSCH EPRE of the CSI-RS antenna ports associated with a CSI-RS resource), a PDSCH EPRE selection indication (e.g., a selection field with ‘bit 0’ or ‘bit 1’), and/or a correction factor.

At 404 the WTRU may determine if the second transmit power (e.g., level) of the CSI-RS resources is the same. For example, the WTRU may determine if the second transmit power (e.g., level) of all of the CSI-RS resources is the same. At 406 the WTRU may determine a third power level, for example if the WTRU determines that the second transmit power (e.g., level) of (e.g., all) of the CSI-RS resources is not the same. The WTRU may determine the third power level based on the state value of the flag indication(s) and/or the correction factor associated with CSI-RS resources in a CSI-RS resource set. For example, if the flag indication associated with a first CSI-RS resource in a first CSI-RS resource set is “bit 1”, then, the third power level may equal the second power level associated with the first CSI-RS resource in a first CSI-RS resource set combined with the correction factor associated with the first CSI-RS resource in the first CSI-RS resource set. At 408 the WTRU may determine if the first power level of the CSI-RS resources is the same. For example, the WTRU may determine if the first transmit power (e.g., level) of all of the CSI-RS resources is the same.

The WTRU may determine a (e.g., first) matrix (e.g., a power and/or amplitude scaling matrix), a first factor, and/or a first value, for example based on one or more of the first power level associated with each CSI-RS resource in the CSI-RS resource set and/or based on the determined third power level. The WTRU may use the determined (e.g., first) matrix, a factor, and/or a value to compensate the CSI. The WTRU may determine CSI with compensation factor at 410, for example if the WTRU determines that the first transmit power (e.g., level) of (e.g., all) of the CSI-RS resources is not the same. The WTRU may determine CSI without compensation factor at 412, for example if the WTRU determines that the first transmit power (e.g., level) of (e.g., all) of the CSI-RS resources is the same. The WTRU may determine a CSI based on one or more of a hypothetical DL transmission that has a power level equal to the third power level and/or a precoder structure. The precoder structure may include the first matrix. The first matrix may be used to compensate the CSI, for example by scaling the precoder weights associated with one or more CSI-RS antenna ports. At 414 the WTRU may report the CSI, for example to the network. For example, the WTRU may report the CSI after determining the CSI with compensation factor at 410 and/or after determining CSI without compensation factor at 412.

The WTRU may determine if the configured power setting is balanced or imbalanced. The WTRU may determine a third power level and/or derive a CSI, for example assuming a downlink transmission power equal to the third power level. The WTRU may compensate the derived CSI, for example by scaling the channel matrix and/or by scaling the determined precoder. For example, the WTRU may compensate the derived CSI when the configured power setting is imbalanced. If the WTRU determines that the CSI-RS resources are configured with imbalanced power setting for example, the WTRU may determine the power level of a hypothetical downlink (DL) transmission using implicit or explicit indications. The power level of the hypothetical DL transmission that may be used by the WTRU when determining a CSI. Additionally, or alternatively, if the TRU determines that the CSI-RS resources are configured with imbalanced power setting for example, the WTRU may compensate CSI at the precoder level and/or at the channel matrix level. The WTRU may determine a CSI that is an accurate estimation of the wireless channel, for example when the CSI-RS resources are configured with imbalanced power setting.

Herein a transmission and reception point (TRP) may be interchangeably used with one or more of a transmission point (TP), a reception point (RP), a radio remote head (RRH), a distributed antenna (DA), a base station (BS), a sector of a BS, and/or a cell (e.g., a geographical cell area served by a BS). Herein multi-TRP may be interchangeably used with one or more of MTRP, M-TRP, and/or multiple TRPs. A WTRU may report a subset of CSI components. CSI components may correspond to one or more of a CSI-RS resource indicator (CRI), a SSB resource indicator (SSBRI), an indication of a panel used for reception at the WTRU (e.g., a panel identity and/or group identity), measurements such as L1-RSRP, L1-SINR taken from SSB or CSI-RS (e.g. cri-RSRP, cri-SINR, ssb-Index-RSRP, ssb-Index-SINR), and/or other channel state information such as at least rank indicator (RI), channel quality indicator (CQI), precoding matrix indicator (PMI), layer Index (LI), and/or the like.

Herein a signal may be interchangeably used with one or more of sounding reference signal (SRS), CSI_RS, demodulation reference signal (DM-RS), phase tracking reference signal (PT-RS), and/or synchronization signal block (SSB). Herein a channel may be interchangeably used with one or more of physical downlink control channel (PDCCH), physical downlink shared channel (PDSCH), physical uplink control channel (PUCCH), physical uplink shared channel (PUSCH), and/or physical random access channel (PRACH), etc. Herein a quantity, report quantity, and/or channel state information (CSI) may be interchangeably used with one or more of rank indicator (RI), precoding matrix indicator (PMI), channel quality indicator (CQI), wideband channel quality indicator (W-CQI), sub-band channel quality indicator (S-CQI), wideband precoding matrix indicator (i1), layer indicator (LI), CSI reference resource index (CRI), signal to noise and interference ratio (SINR), and/or reference signal received power (RSRP), etc.

Herein the term power may be interchangeably used with the terms, energy, power of one resource element (EPRE), transmit power level, and/or transmitting power. Herein downlink transmission and/or downlink reception may be used interchangeably with Rx occasion, PDCCH, PDSCH, and/or SSB reception. Herein uplink transmission or uplink reception may be used interchangeably with Tx occasion, PUCCH, PUSCH, PRACH, and/or SRS transmission. Herein RS may be interchangeably used with one or more of RS resource, RS resource set, RS port and/or RS port group. Herein RS may be interchangeably used with one or more of SSB, CSI-RS, SRS, and/or DM-RS. Herein time instance or time-unit may be interchangeably used with slot, symbol, and/or subframe. Herein frequency instance or frequency unit may be interchangeably used with subcarrier, resource element (RE), sub-band, band, and/or bandwidth part. Herein the terms prediction, determination, calculation, and estimation may be used interchangeably. Herein the terms hypothetical DL transmission power level may be interpreted, considered, treated, assumed, or processed by a device (e.g., by a receiver or a WTRU) as the DL transmission power level of a device (e.g., a transmitter, a base station, a gNB, and/or eNB), for example when it may perform DL transmissions. Herein sub-set of antenna unit(s), and/or subset of pilot symbol(s) may be interchangeably used with CSI-RS resource(s). Herein the term, “first power level” or “first power” may refer to EPRE of CSI-RS, the power level of a subset of pilot symbol(s), the power level of the antenna unit(s) transmitting the subset of pilot symbol(s), the EPRE of a CSI-RS resource, and/or the power level of each pilot symbol. Herein the term, “antenna unit” may refer to a physical antenna element and/or a logical antenna port etc. Herein the terms, “power” and “amplitude” may be interchangeably used.

Herein the term, “first power level” may be interchangeably used with EPRE of CSI-RS, for example where EPRE of CSI-RS may be determined based on a mathematical relation. For example EPRE of CSI-RS may be determined based on:

$$EPRE of CSI - RS = \frac{EPRE of PBCH}{powerControlOffsetss} , or$$

$$EPRE of CSI - RS = \frac{EPRE of hypothetical PDSCH}{powerControlOffset}$$

Herein the term, “second power level” may be interchangeably used with EPRE of hypothetical PDSCH, for example where EPRE of hypothetical PDSCH may be given based on:

$$EPRE of hypothetical PDSCH = powerControlOffset \times EPRE of CSI - RS$$

Systems and methods as disclosed herein may be for when a CSI is determined based on one or more CSI-RS resources in a CSI-RS resource set. Additionally, or alternatively, systems and methods as disclosed herein may be for when CSI is determined based on CSI-RS resources that belongs to or are associated to different CSI-RS resource set(s). Herein the first power level, the second power level, and/or the third power level may be treated as the power level per antenna unit(s), the power level(s) equally or the power level(s) un-equally divided among the antenna unit(s).

A CSI determination condition may be supported. For example CSI determination may be supported based on multiple CSI-RS resources that satisfy:

$$\frac{{p}_{11}}{EPRE of SS} = powerControlOffset ss 1 \qquad ( 1 a )$$

$$\frac{{p}_{12}}{EPRE of SS} = powerControlOffsetss 2 \qquad ( 1 b )$$

$$\frac{{p}_{21}}{EPRE of RS 1} = powerControlOffset 1 \qquad ( 2 a )$$

$$\frac{{p}_{22}}{EPRE of RS 2} = powerControlOffset 2 \qquad ( 2 b )$$

Substituting (1a) and (1b) into (2a) and (2b), respectively, yields

$$\frac{{p}_{21}}{powerControlOffsetss 1 \times ( EPRE of SS )} = powerControlOffset 1 \qquad ( 3 a )$$

$$\frac{{p}_{22}}{powerControlOffsetss 2 \times ( EPRE of SS )} = powerControlOffset 2 \qquad ( 3 a )$$

64 CSI-RS antenna ports may support CSI for the case when the 64 CSI-RS ports aggregated across two CSI-RS resources satisfy p₂₁=p₂₂ and p₁₁=p₁₂, for example when p₂₁=p₂₂. Equating (3a) and (3b) may yields:

$$powerControlOffset 1 \times ( powerControlOffsetss 1 \times ( EPRE of SS ) ) = powerControlOffset 2 \times ( powerControlOffsetss 2 \times ( EPRE of SS ) ) \qquad ( 4 )$$

Simplifying (4) results in,

$$\frac{powerControlOffset 1}{powerControlOffset 2} = \frac{powerControlOffsetss 2}{powerControlOffsetss 1} \qquad ( 5 )$$

A WTRU may determine if a condition, for example as specified by equation 5, is satisfied or not when the gNB configures the CSI-RS resources for CSI determination (e.g., whether the condition holds true or not). The WTRU may determine a CSI report and report the CSI report, for example when the condition is satisfied. The WTRU may use a first precoder mode (e.g., precoder mode-1 to determine the CSI report, where precoder mode-1 may be the same precoders supported in the existing specifications), for example when the condition is satisfied.

The WTRU may use a second precoder mode (e.g., precoder mode-2 to determine the CSI report, where precoder mode-2 may be the same precoders supported in the existing specifications with some enhancements, e.g., the precoder mode-1 scaled by a matrix gives precoder mode-2), for example when the condition is not satisfied. The WTRU may ignore one or more of the scheduling grant, scheduling DCI, indications for reporting the CSI and CSI configurations, and/or drop the CSI report, for example when the condition is not satisfied. The WTRU may not consider the configured CSI resources as active resource (e.g., even though a CSI-RS resource is received, the WTRU may not determine a CSI based on the configuration resources, the WTRU may not count the resource as active and may assume that the gNB knows that the WTRU did not count the resource(s) as active resources), for example when the condition is not satisfied. The WTRU may not use any computational resources for determination of the CSI report (e.g., the occupied number of CPU for the configured CSI report is zero), for example when the condition is not satisfied. The WTRU may use a second precoder mode (e.g., precoder mode-2 to determine the CSI report, where precoder mode-2 may be based on one or more of the procedures herein), for example when the condition is not satisfied.

A WTRU may include one or more capabilities. The WTRU may send a capability report, for example to the gNB, to indicate whether the WTRU can determine a CSI using one or more of the procedures, methods, or proposals presented in this disclosure. For example, the WTRU may send a capability report indicating that the WTRU may support CSI determination based on one or more of the procedures related to third power level, based on procedures related to scaling of the channel matrix, and/or based on procedures related to scaling the precoder.

The WTRU may send a capability report (e.g., to the gNB) to indicate that the WTRU may support CSI determination, for example (e.g., even) when the condition in equation 5 is not satisfied within some tolerance (e.g., threshold). For example, the WTRU may declare that the WTRU may support CSI determination based on (e.g., the condition):

$$\frac{powerControlOffset 1}{powerControlOffset 2} = \frac{powerControlOffsetss 2}{powerControlOffsetss 1} + γ \qquad ( 6 )$$

where γ may be a scaler value.

The WTRU may declare the supported value of γ. The WTRU may determine if the condition in equation (6) is satisfied or not satisfied. If the condition is satisfied for example, the WTRU may determine a CSI without CSI compensation factor. Additionally, or alternatively, if the condition is satisfied for example, the WTRU may determine a CSI and/or compensate the determined CSI using at least one method or procedure as herein.

A system model is disclosed herein. A transmitter may have Nₜ transmit antenna units and/or a receiver may have Nᵣ receive antenna units. A channel matrix H between the transmitter and the receiver may be denoted by a channel matrix with dimension Nᵣ×Nₜ. To sound, estimate, calculate, determine, or predict the channel matrix, the transmitter may send pilot symbols and/or RSs (e.g., CSI-RS resources) denoted by X=[x₁, . . . , x_{N}_{ₜ}] to a WTRU. A subset of the pilot symbol xₙ, n=1 . . . , Nₜ in X may transmitted using a transmitting antenna unit at a power level p₁. The pilot symbols may be known to the WTRU. The WTRU may receive the pilot symbols, which for example may be expressed as:

$$Y = {p}_{1} HX$$

In the above equation, the thermal noise term(s) may be excluded for simplicity. However the solutions proposed in this disclosure may equally, extendedly, or similarly be applicable for cases considering the effects of thermal noise at the transmitter and/or at the receiver. Based on the received Y, an/or the knowledge of the pilot symbols X and the power level of the pilot symbols p₁, the WTRU may determine an estimate (e.g., \tilde{H} of the actual wireless channel H). The WTRU may determine and/or derive a channel quality indicator and/or a quantity (e.g., RI, PMI, CQI, etc.), for example that may represent a measure of the wireless channel based on the channel matrix \tilde{H} and/or based on a hypothetical power level p₂ (e.g., that the transmitter may use when transmitting some data to the WTRU based on the channel quality or quantity reports that the receiver may send to the transmitter).

Power setting are disclosed herein. One or more antenna unit(s) may have an associated implicit or explicit semi-static or dynamic (e.g., by RRC, MAC-CE, and/or DCI) indication(s). The indication(s) may indicate one or more of a first transmit power (e.g., level), a second transmit power (e.g., level), and/or a semi-static or a dynamic (e.g., by RRC, MAC-CE, and/or DCI) indication of a first power level and/or a second power level associated with one or more antenna unit(s) in one or more subset of antenna unit(s).

The indication may indicate a first transmit power (e.g., level). The first transmit power (e.g., level) may be a transmit power (e.g., level) of one or more antenna units at the time of transmission of the pilot symbols. For example, the transmit power (e.g., level) may be the transmit power (e.g., level) of the first antenna unit at the time of transmission of the first pilot symbol (e.g., x₁ is p₁₁) and/or the transmit power (e.g., level) of the second antenna unit at the time of transmission of the second pilot symbol (e.g., x₂ is p₁₂). In some examples, the transmit power (e.g., level) of the first pilot (e.g., x₁) may be p₁₁ and the transmit power (e.g., level) of the second pilot symbol, (e.g., x₂) may be p₁₂.

The indication may indicate a second transmit power (e.g., level). The second transmit power may be a transmit power (e.g., level) of one or more antenna units that the WTRU may assume or consider when determining, calculating, or predicting a CSI based on the pilot symbol(s) may be transmitted at a first power level(s). For example, when the receiver receives the pilot symbols at a first power level p₁, the receiver may determine a CSI based on the received pilot symbols and/or an assumption of a second transmit power (e.g., level) (e.g., p₂) across one or more antenna units when transmitting data to the WTRU. In some examples, the receiver may receive the pilot symbol(s) that may be transmitted at power level(s) p₁ (p₁₁,p₁₂, . . . ). The WTRU may receive the pilot symbols and/or make an estimate of the wireless channel (e.g., H), for example based on the received pilot symbols. The receiver may derive, determine, calculate, or predict a quantity and quantities (e.g., RI, PMI, CQI) based on the estimate of the wireless channel and/or based on an assumption that the transmitter may use a power level equal to the second power level at (e.g., or across) one or more antenna unit(s), for example when it uses the reported quantity or quantities to assist data transmission towards the WTRU.

The WTRU may receive a semi-static or a dynamic (e.g., by RRC, MAC-CE, and/or DCI) indication of a first power level and/or a second power level associated with one or more antenna unit(s) in one or more subset of antenna unit(s). For example, the antenna units may be divided into two subsets of antenna units (e.g., a first sub-set of antenna units and a second subset of antenna units). The first subset of antenna units and the second subset of antenna units may include Nₜ₁ number of antenna units and Nₜ₂ number of antenna units, respectively. The WTRU may receive an RRC, MAC-CE, and/or DCI based indication of a first transmit power (e.g., level) indication and a second transmit power (e.g., level) indication for each antenna unit in the sub-set of antenna units. Additionally, or alternatively, the WTRU may receive an RRC, MAC-CE, and/or DCI based indication of a first transmit power (e.g., level) indication and a second transmit power (e.g., level) indication for all antenna units in the sub-set of antenna units, for example where the first transmit power (e.g., level) indication and/or the second transmit power (e.g., level) indication is common for all antenna unit(s) in the sub-set of antenna units.

There may be balanced and imbalanced power settings. Based on the first transmit power (e.g., level) and/or the second transmit power (e.g., level) for example, the power setting of the first transmit power (e.g., level) and/or second transmit power (e.g., level) may be classified into balanced power setting and/or imbalanced power setting. The power setting of the first transmit power (e.g., level) and/or second transmit power (e.g., level) may be classified into balanced power setting. When the first transmit power (e.g., level) for all antenna unit(s) in a subset of antenna unit(s) is the same and/or the second transmit power (e.g., level) for all antenna unit(s) in a subset of antenna unit(s) is the same for example, the power setting of the first transmit power (e.g., level) and/or second transmit power (e.g., level) may be classified into balanced power setting. For example, a first subset of antenna units may have two antenna units. The first antenna unit in the first subset of antenna units may have an associated first transmit power (e.g., level) p₁₁. The second antenna unit in the first subset of antenna units may have an associated first transmit power (e.g., level) p₁₂, and p₁₁=p₁₂. The first antenna unit in the first subset of antenna units may have an associated second transmit power (e.g., level) equal to p₂₁. The second antenna unit in a first subset of antenna units may have an associated second transmit power (e.g., level) equal to p₂₂, and p₂₁=p₂₂. When p₁₁=p₁₂ and p₂₁=p₂₂ for example, the power setting of the first transmit power (e.g., level) and/or second transmit power (e.g., level) may be classified into balanced power setting.

The power setting of the first transmit power (e.g., level) and/or second transmit power (e.g., level) may be classified into imbalanced power setting. When the first transmit power (e.g., level) of one or more antenna unit(s) in a subset of antenna unit(s) is different and/or the second transmit power (e.g., level) of one or more antenna unit(s) in a subset of antenna unit(s) is different, the power setting of the first transmit power (e.g., level) and/or second transmit power (e.g., level) may be classified into imbalanced power setting. For example, a first subset of antenna units may have two antenna units. The first antenna unit in the first subset of antenna units may have an associated first transmit power (e.g., level) p₁₁. The second antenna unit in the first subset of antenna units may have an associated first transmit power (e.g., level) p₁₂. The first antenna unit in the first subset of antenna units may have an associated second transmit power (e.g., level) equal to p₂₁ and/or the second antenna unit in a first subset of antenna units may have an associated second transmit power (e.g., level) equal to p₂₂. When p₁₁≠p₁₂ and/or p₂₁≠p₂₂ for example, the power setting of the first transmit power (e.g., level) and/or second transmit power (e.g., level) may be classified into imbalanced power setting. The imbalanced power setting may be associated with (e.g., include) one or more of p₁₁=p₁₂ and p₂₁≠p₂₂; p₁₁≠p₁₂ and p₂₁=; and/or p₁₁≠p₁₂ and p₂₁≠p₂₂.

The imbalanced power setting may be classified as (e.g., divided into) Type-A imbalanced power setting, Type-B imbalanced power setting, and/or Type-C imbalanced power setting. The imbalanced power setting may be classified as Type-A imbalanced power setting. For example the imbalanced power setting may be classified as Type-A imbalanced power setting when the power setting is imbalanced due to the first power level(s) (e.g., when the measurement resources are transmitted at different power levels). For example the imbalanced power setting may be classified as Type-A imbalanced power setting when the transmit power (e.g., level) of a first CSI-RS resource is p₁₁ and/or the transmit power (e.g., level) of a second CSI-RS resource is p₁₂, and p₁₁≠p₁₂.

The imbalanced power setting may be classified as Type-B imbalanced power setting. For example the imbalanced power setting may be classified as Type-B imbalanced power setting when the power setting is imbalanced due to the second power level(s). For example the imbalanced power setting may be classified as Type-B imbalanced power setting when the second power level associated with a first CSI-RS resource is different than the second power level associated with the second CSI-RS resource (e.g., p₂₁≠p₂₂).

The imbalanced power setting may be classified as Type-C imbalanced power setting. For example imbalanced power setting may be classified as Type-C imbalanced power setting when the power setting is imbalanced due to the first and the second power levels. For example, imbalanced power setting may be classified as Type-C imbalanced power setting when p₁₁≠p₁₂ and p₂₁≠p₂₂.

A hypothetical downlink power level and/or a third power level assumption for CSI determination is disclosed herein. When the CSI-RS resources are configured with imbalanced power settings for example (e.g., especially when the second power level for one or more CSI-RS resources, sub-set of antenna unit(s), sub-set of pilot symbol(s) is different, e.g., when p₂₁≠p₂₂), CSI determination may be based on the assumption that the downlink transmissions using the first subset of antenna unit(s) at power level p₂₁ and a second subset of antenna unit(s) at power level p₂₂ would result in an inaccurate determination of the CSI. When the transmitter or gNB uses the same power level at the first subset of antenna unit(s) and the second subset of antenna unit(s) when it transmit data towards the WTRU, CSI determination may be based on the assumption that the downlink transmissions using the first subset of antenna unit(s) at power level p₂₁ and a second subset of antenna unit(s) at power level p₂₂ would result in an inaccurate determination of the CSI (e.g., would result in a CSI that is an inaccurate representation of the wireless channel). The WTRU may determine a hypothetical downlink power level that is the same for all subset of antenna unit(s) used for downlink transmission. The WTRU determining a hypothetical downlink power level that is the same for all subset of antenna unit(s) used for downlink transmission, for example when imbalanced power setting is configured, may be associated with (e.g., known as) a third power level throughout this disclosure.

One or more of the CSI-RS resources in a CSI-RS resource set used for determination of a CSI report may (e.g., also) have an associated indication, for example that may be indicated semi-statically or dynamically (e.g., by RRC, MAC-CE, and/or DCI). The indicator may indicate a scaling factor and/or a correction factor for scaling the second power level associated with a CSI-RS resource. For example, the CSI-RS resource set may have two CSI-RS resources. The first CSI-RS resource may have an associated second power level equal in value to p₂₁ and/or the second CSI-RS resource may have an associated second power level equal in value to p₂₂. The WTRU may receive an indication of scaling factors (e.g., α₁ and α₂), for example where α₁ and α₂ may be associated with the first and second CSI-RS resources in a CSI-RS resource set, respectively.

The WTRU may determine a third power level for a CSI-RS resource, for example by combining the second power level of the CSI-RS resource with the scaling factor associated with the CSI-RS resource. For example, the third power level for a first CSI-RS resource may be p₃₁, where

$${p}_{31} = {p}_{21} \times {α}_{1} or {p}_{31} = \frac{{p}_{21}}{{α}_{1}} .$$

The third power level for a second CSI-RS resource may be p₃₂, where

$${p}_{32} = {p}_{22} \times {α}_{2} or {p}_{32} = \frac{{p}_{22}}{{α}_{2}} .$$

In some examples p₃₁ may be equal to p₃₂ and/or p₃₁ may not be equal to p₃₂.

Case A may refer to a case where p₃₁≠p₃₂. When p₃₁ is not equal to p₃₂ for example, the WTRU may determine a CSI assuming that the downlink transmission will occur on subset of antenna unit(s). The subset of antenna units may use different transmission power levels (e.g., p₃₁≠p₃₂). When a sub-set of the antenna unit(s) on the antenna panel experience physical blockage (e.g., blockage due to object or in deep fading scenario as compared to the other sub-sets on the same panel) for example, Case A may be utilized.

Case B may refer to a case where p₃₁=p₃₂. When p₃₁ is equal to p₃₂ for example, the WTRU may determine a CSI assuming that the downlink transmission will occur on subset of antenna unit(s). The subset of antenna units may use the same transmission power levels (e.g., p₃₁=p₃₂).

The correction factor may be combined with the second power level, for example based on one or more of:

$${p}_{31} = {p}_{21} \times {α}_{1} ; {p}_{31} = \frac{{p}_{21}}{{α}_{1}} or \frac{{α}_{1}}{{p}_{21}} ; {p}_{31} = {p}_{21} - {α}_{1} or {α}_{1} - {p}_{21} ; \frac{a n d}{o r}$$

$${p}_{31} = {p}_{21} + {α}_{1}$$

(e.g., explained using p₃₁, p₂₁, and α₁ and mathematical relations).

One or more CSI-RS resources in a CSI-RS resource set may have an associated semi-statically or dynamically (e.g., by RRC, MAC-CE, and/or DCI) indicated indication. The indication may indicate an index of a CSI-RS resource in a CSI-RS resource set. For example, each CSI-RS resource in a CSI-RS resource set may have a single bit indication. When the state value of the single bit indicator associated with a CSI-RS resource is “1” for example, that CSI-RS resource may be considered, assumed, or used as a reference CSI-RS resource by the WTRU for determination of the third power level.

The WTRU may determine the third power level based on the reference CSI-RS resource, (e.g., the indicated reference CSI-RS resource), and/or based on the first power level and/or the second power level associated with the reference CSI-RS resource. For example, a CSI-RS resource set may have two CSI-RS resources. The first and second CSI-RS resources may have associated second power levels equal to p₂₁ and p₂₂, respectively. The first and/or the second CSI-RS resources may have associated single bit flag indication(s). The flag indication associated with the second CSI-RS resource may be 1 and/or the flag indication associated with the first CSI-RS resource may be 0. The reference CSI-RS resource may (e.g., therefore) be the second CSI-RS resource. The third power level associated with the antenna unit(s) of the first and second CSI-RS resources may be p₃₁=p₂₂ and p₃₂=p₂₂, respectively.

One or more CSI-RS resources in a CSI-RS resource set may have associated indications for the correction factors and/or for indication of the reference CSI-RS resource. For example the third power level for one or more CSI-RS resources in the CSI-RS resource set may equal the second power level of the reference resource combined with the correction factor and/or scaling factor associated with the reference CSI-RS resource in the CSI-RS resource set. For example, a CSI-RS resource set may have two CSI-RS resources. The first and second CSI-RS resources may have associated second power levels equal to p₂₁ and p₂₂, respectively. The first and/or the second CSI-RS resources may have associated single bit flag indications. The flag indication associated with the second CSI-RS resource may be 1 and/or the flag indication associated with the first CSI-RS resource may be 0. The reference CSI-RS resource may (e.g., therefore) be the second CSI-RS resource. The correction factor associated with the first CSI-RS resource may be α₁ and/or the correction factor associated with the second CSI-RS resource may be α₂. The third power level associated with the antenna unit(s) of the first and second CSI-RS resources may equals p₃₁=α₂p₂₂ and p₃₂=α₂p₂₂, respectively.

The WTRU may determine the third power level for antenna unit(s) associated with one or more CSI-RS resources in a CSI-RS resource set based on one or more of the mean (e.g., average), median, sum, maximum, and/or minimum of the second power levels associated with one or more CSI-RS resources in a CSI-RS resource set. For example, the CSI-RS resource set may have two CSI-RS resources. The second power level of the first CSI-RS resource may be p₂₁ and/or the second power level of the second CSI-RS resource may be p₂₂. The third power level for the antenna units(s) associated with first and second CSI-RS resources, denoted as p₃=p₃₁=p₃₂ may be one or more of p₃=p₂₁+p₂₂, p₃=p₂₁−p₂₂, or p₃=p₂₂−p₂₁; p₃=mean (p₂₁, p₂₂); p₃=maximum (p₂₁, p₂₂); p₃=minimum (p₂₁, p₂₂); and/or p₃=p₂₁ or p₃=p₂₂.

CSI compensation factor is disclosed. When imbalanced power setting is configured (e.g., when Type-B imbalanced power setting or Type-C imbalanced power setting is configured) for example, the WTRU may measure the wireless channel based on CSI-RS resources with different values of first power levels. For example, a CSI-RS resource set may have two CSI-RS resources. The first CSI-RS resource may have a first power level equal to p₁₁ and/or the second CSI-RS resource may have a first power level equal to p₁₂. When p₁₁ is not equal to p₁₂ for example, the WTRU may makes an estimation (e.g., H) of the actual wireless channel (e.g., H). Based on A for example, the WTRU may derive report quantities that represent and/or reflect the behavior and/or condition of the wireless channel denoted by H. When Type-B or Type-C imbalanced power setting is configured for example, the determined quantities may not be an accurate estimation of the wireless channel. Compensation factor may be (e.g., therefore) utilized to determine quantities that accurately represents the wireless channel H.

The WTRU may determine report quantities and/or CSI by solving an optimization problem, for example that involves the determined channel matrix A. For example, the WTRU may determine a precoder Wᵢ, i∈{1, . . . , M} from a codebook of precoders that has M number of precoders, for example by solving an optimization problem. The optimization problem may maximize. An example optimization problem may include: maximize (Cᵢ; Wᵢ), for all i, where Cᵢ is the Shannon capacity, e.g., Cᵢ=log₂(1+p₃\tilde{H}Wᵢ) of a hypothetical downlink transmission at a power level of p₃ when applying the precoder W; at the transmitter. A power scaling matrix may compensate the determined report quantities and/or CSI, for example based on an optimization problem.

Design of a power scaling matrix is disclosed herein. The WTRU may estimate the channel matrix (e.g., H) and/or estimate a power scaling channel matrix (e.g., Wₚ). The WTRU may compensate the CSI, for example based on the power scaling matrix. The WTRU may compensate the CSI by including, considering, or using the power scaling matrix to solve an optimization problem. For example, a CSI-RS resource set may have two CSI-RS resources. The first CSI-RS resource may have Nₜ₁ number of antenna unit(s) and/or the second CSI-RS resource may have Nₜ₂ number of antenna unit(s), for example where the total number of antenna unit(s) associated with the CSI-RS resource set equal Nₜ=Nₜ₁+Nₜ₂. The first CSI-RS resource may have a first transmit power (e.g., level) p₁₁ and/or the second CSI-RS resource may have a first power level p₁₂. The WTRU may receive a semi-static or dynamic indication (e.g., by RRC, MAC-CE, and/or DCI), for example that indicates the index of a reference CSI-RS resource among the CSI-RS resources in the CSI-RS resource set.

The reference CSI-RS resource may be a reference CSI-RS resource disclosed herein, for example related to determination of the third power level herein or to other indications methods or procedures. For example, the reference resource may be the first CSI-RS resource. The WTRU may determine an RSRP value and/or a reference RSRP value, for example based on one or more antenna unit(s) associated with the reference resource (e.g., the reference RSRP value determined based on the first antenna unit(s) associated with the reference CSI-RS resource may be RSRP1). The WTRU may determine RSRP values for the remaining CSI-RS resources. For example the WTRU may determine a RSRP value based on one or more antenna unit(s) associated with the second CSI-RS resource (e.g., RSRP2). The WTRU may determine a difference of the RSRP value for each CSI-RS resource relative to the reference CSI-RS resource. For example, the WTRU may determine 42=RSRP1-RSRP2.

The WTRU may determine coefficient value(s) for each CSI-RS resource, for example based on one or more of the first power level associated with the reference resource, the first power levels associated with the remaining resources, the determined RSRP value of the reference resource, and/or the determined RSRP values of the remaining resources. For example, the coefficient value for the second CSI-RS resource may equal δ₂=p₁₁−p₁₂, or δ₂=Δ₂. The coefficient value for the reference CSI-RS resource, which is the first CSI-RS resource may equal δ₁=1.

The WTRU may determine or create a power scaling matrix Wₚ, for example based on the determined coefficient values. For example, the estimated channel matrix may have a dimension equal to Nᵣ×Nₜ, where Nₜ=Nₜ₁+Nₜ₂ and where Nₜ is the total number of transmit antenna unit(s) across the CSI-RS resources and/or where Nᵣ is the total number of receive antenna unit(s). The power scaling matrix may be a diagonal matrix with a dimension equal to Nₜ×Nₜ. For example, the diagonal entries and/or coefficients of the power scaling matrix that are associated with the antenna unit(s) of the reference resource may be (e.g., all) equal to one. For example, the first Nₜ₁ entries of the power scaling matrix may all equal one, for example if p₁₁ is the first power level per antenna unit of the first CSI-RS resource. For example, the diagonal entries and/or coefficients of the power scaling matrix that are associated with the antenna unit(s) of the reference resource may all equal to one divided by the Nₜ₁, for example if p₁₁ is the first power level divided among the Nₜ₁ antenna units associated with the reference CSI-RS resource.

In some examples, the first Nₜ₁ entries of the power scaling matrix may all equal to

$$\frac{1}{{N}_{t 1}} ,$$

for example if p₁₁ is the first power level divided among the antenna units of the first CSI-RS resource. The diagonal entries, elements, and/or coefficients of the power scaling matrix that are associated with the antenna unit(s) of a CSI-RS resource may (e.g., all) equal the coefficient value (e.g., δ₂ or Δ₂), for example determined for that CSI-RS resource. The Nₜ₂ entries of the power scaling matrix may (e.g., all) equal δ₂, for example if p₁₂ is the first power level per antenna unit of the second CSI-RS resource. The diagonal entries and/or coefficients of the power scaling matrix that are associated with the antenna unit(s) of the second CSI-RS resource may (e.g., all) equal δ₂ divided by Nₜ₂, for example if p₁₂ is the first power level divided among the Nₜ₂ antenna units. The Nₜ₂ entries of the power scaling matrix associated with the second CSI-RS resource may (e.g., all) equal to

$$\frac{{δ}_{2}}{{N}_{t 2}} ,$$

for example if p₁₂ is the first power level divided among the Nₜ₂ antenna units of the second CSI-RS resource. The power scaling matrix may have a dimension equal to Nₜ×Nₜ. The power scaling matrix for two CSI-RS resources may be denoted as:

$${W}_{p} = [ \begin{matrix}{δ}_{1} ( 1 , 1 ) & … & … & … & … & 0 \\ ⋮ & ⋱ & ⋮ & ⋮ & ⋮ & ⋮ \\ ⋮ & ⋮ & {δ}_{1} ( 1 , {N}_{t 1} ) & ⋮ & ⋮ & ⋮ \\ ⋮ & ⋮ & ⋮ & {δ}_{2} ( 2 , 1 ) & ⋮ & ⋮ \\ ⋮ & ⋮ & ⋮ & ⋮ & ⋱ & ⋮ \\ 0 & … & … & … & … & {δ}_{2} ( 2 , {N}_{t 2} )\end{matrix} ]$$

For example where δ₁(1, 1) may be the coefficient value for the first antenna unit of the first CSI-RS resource, δ₁(1, Nₜ₁) may be the coefficient value for the Nₜ₁-th antenna unit of the first CSI-RS resource, δ₂(2, 1) may be the coefficient value for the first antenna unit of the second CSI-RS resource, and/or δ₂(2, Nₜ₁) may be the coefficient value for the Nₜ₂-th antenna unit of the second CSI-RS resource.

The WTRU may determine the power scaling matrix, for example based on a pre-defined rule. An example rule may be for a CSI-RS resource set with two CSI-RS resources. For example a first CSI-RS resource may be configured with a first power level equal to p₁₁ and/or a second power level equal to p₂₁. A second CSI-RS resource may be configured with a first power level equal to p₁₂ and/or a second power level equal to p₂₂. The WTRU may receive an indication that indicates the reference CSI-RS resource. The WTRU may determine the diagonal entries of the power scaling matrix. For example when the reference CSI-RS resource is the first CSI-RS resource, the diagonal entries of the power scaling matrix associated with the first CSI-RS resource may (e.g., all) equal one and/or the diagonal entries associated with the second CSI-RS resource may be one or more of:

$$powerControloffset 1 = \frac{{p}_{21}}{{p}_{11}}$$

$$powerControloffset 2 = \frac{{p}_{22}}{{p}_{12}}$$

$${p}_{21} = {p}_{11} \times powerControloffset 1$$

$${p}_{22} = {p}_{12} \times powerControloffset 2$$

Since p₂₁=p₂₂,

$${p}_{12} = {p}_{11} \times \frac{powerControloffset 1}{powerControloffset 2}$$

When the reference CSI-RS resource is the second CSI-RS resource for example, the diagonal entries of the power scaling matrix associated with the second CSI-RS resource may (e.g., all) be equal to one and/or the diagonal entries associated with the first CSI-RS resource may be:

$${p}_{11} = {p}_{12} \times \frac{powerControloffset 2}{powerControloffset 1}$$

For example, when the first CSI-RS resource is the reference CSI-RS resource, the power scaling matrix may be:

$${W}_{p} = [ \begin{matrix}1 ( 1 , 1 ) & … & … & … & … & 0 \\ ⋮ & ⋱ & ⋮ & ⋮ & ⋮ & ⋮ \\ ⋮ & ⋮ & 1 ( 1 , {N}_{t 1} ) & ⋮ & ⋮ & ⋮ \\ ⋮ & ⋮ & ⋮ & {p}_{11} ( 2 , 1 ) & ⋮ & ⋮ \\ ⋮ & ⋮ & ⋮ & ⋮ & ⋱ & ⋮ \\ 0 & … & … & … & … & {p}_{11} ( 2 , {N}_{t 2} )\end{matrix} ]$$

For example, when the second CSI-RS resource is the reference CSI-RS resource, the power scaling matrix may be denoted as,

$${W}_{p} = [ \begin{matrix}{p}_{12} ( 1 , 1 ) & … & … & … & … & 0 \\ ⋮ & ⋱ & ⋮ & ⋮ & ⋮ & ⋮ \\ ⋮ & ⋮ & {p}_{12} ( 1 , {N}_{t 1} ) & ⋮ & ⋮ & ⋮ \\ ⋮ & ⋮ & ⋮ & 1 ( 2 , 1 ) & ⋮ & ⋮ \\ ⋮ & ⋮ & ⋮ & ⋮ & ⋱ & ⋮ \\ 0 & … & … & … & … & 1 ( 2 , {N}_{t 2} )\end{matrix} ]$$

$$CSI compensation factor based on the power scaling matrix$$

Based on the power scaling matrix Wₚ for example, the WTRU may compensate the CSI. For example, the WTRU may compensate the CSI by using the power scaling matrix to scale the determined and/or estimated channel matrix (e.g., (\tilde{H})) and/or scale the selected precoder (e.g., Wᵢ) using the power scaling matrix. CSI compensation factor based on scaling the channel matrix A or scaling the precoder W; is disclosed herein.

There may be CSI compensation factor by scaling the channel matrix. A WTRU may scale the channel matrix using the determined power scaling matrix to compensate for the CSI, for example when Type-B imbalanced power setting and/or Type-C imbalanced power setting is configured for determination of the CSI. Additionally, or alternatively, the WTRU may determines a second wireless channel matrix (e.g., Ĥ), for example by combining the estimate of the wireless channel (e.g., \tilde{H}) with the power scaling matrix Wₚ. For example, the WTRU may determine Ĥ as Ĥ=\tilde{H}Wₚ, where \tilde{H} has a dimension equal to Nᵣ×Nₜ and/or Wₚ has a dimension equal to Nₜ×Nₜ.

The WTRU may solve an optimization problem to determine a CSI, for example based on the second wireless channel matrix A of dimension equal to Nᵣ×Nₜ. For example, the WTRU may determine a precoder Wᵢ, i∈{1, . . . , M} from a codebook of precoders that has M number of precoders, for example by solving an optimization problem (e.g., that maximizes the channel capacity). The optimization problem may be Maximize (Cᵢ; Wᵢ), for all i, where Cᵢ is the Shannon capacity (e.g., Cᵢ=log₂(1+p₃ ĤWᵢ)) of a hypothetical downlink transmission, for example when applying the precoder Wᵢ at the transmitter.

The WTRU may declare a WTRU capability of supporting CSI compensation factor, for example based on the power scaling the determined channel matrix A to the gNB. The WTRU may send an indication to the gNB indicating that the reported CSI has been compensated by the WTRU. The WTRU may (e.g., only) send the determined CSI to the gNB and/or the gNB may determine (e.g., assume) that the WTRU has compensated the CSI (e.g., since the WTRU may support CSI compensation factor).

CSI compensation factor by scaling the determine precoder is disclosed herein. A WTRU may determine a precoder without scaling the initial estimate of the channel matrix (e.g., without scaling the channel matrix \tilde{H}), for example based on a power scaling matrix (e.g., as herein).

The WTRU may determine a precoder by solving an optimization problem, for example that involves an initial estimate of the wireless channel, e.g., \tilde{H}. For example, the WTRU may determine the precoder Wᵢ where i∈{1, . . . , M}. The WTRU may determine a power scaling matrix. For example, the WTRU may determine a power scaling matrix as described herein. The WTRU may scale the determined and/or selected precoder, for example using the determined power scaling matrix. For example, the WTRU may scale the determined precoder Wⱼ using the power scaling matrix Wₚ as, Wₚ×Wⱼ, for example where Wₚ may be a matrix of dimension Nₜ×Nₜ and/or Wᵢ may be a matrix of dimension Nₜ×L, where L is the number of layers.

The WTRU may determine a precoder by solving an optimization problem, for example that involves an initial estimate of the wireless channel (e.g., \tilde{H} and the power scaling matrix Wₚ). For example, the WTRU may determine a precoder Wᵢ, i∈{1, . . . , M} from a codebook of precoders that has M number of precoders, for example by solving an optimization problem (e.g., that maximizes the channel capacity). The optimization problem may be: Maximize (Cᵢ; Wᵢ, Wₚ), for all i, where Cᵢ is the Shannon capacity (e.g., Cᵢ=log₂(1+p₃HWₚWᵢ)), for example of a hypothetical downlink transmission when applying the precoder W=WₚWᵢ at the transmitter.

The WTRU may semi-statically or dynamically (e.g., by RRC, MAC-CE, and/or DCI) receive an indication. The indication may indicate the index of a power scaling matrix within one or more of a fixed, pre-defined, semi-statically, and/or dynamically indicated codebook of power scaling matrices. For example, one or more codebooks of Wₚ matrices may be defined. The WTRU may receive an indication of a codebook of Wₚ matrices. The WTRU may receive (e.g., another) indication, for example that indicates the index of a Wₚ matrix within the codebook of Wₚ matrices. For example, the WTRU may use the indicated power scaling matrix to scale the initial estimate of the channel matrix \tilde{H} and/or scale the selected or determined precoder Wᵢ. The WTRU may determine and/or select a power scaling matrix from a codebook of power scaling matrices. The WTRU may reports the index of the power scaling matrix that may be selected from a codebook of power scaling matrices for determination of the CSI report, for example in the same report as the determined CSI. For example, the WTRU may select a power scaling matrix from a codebook of power scaling matrices and/or use the power scaling matrix during determination of the CSI report.

A WTRU may determine CSI, for example based on configuration information, for example configured CSI-RS resources. The WTRU may receive configuration information, for example a CSI-RS resource configuration. The CSI-RS resource configuration may include a first set of indications for one or more of a number of CSI-RS resource set(s), a number of CSI-RS resource(s) in a CSI-RS resource set, and/or a number and indexes of CSI-RS antenna ports associated with the CSI-RS resource(s) in the CSI-RS resource set(s).

One or more of the CSI-RS resources in a CSI-RS resource set may have an associated second set of indications. The second set of indications may indicate one or more of a first power level, (e.g., EPRE of the CSI-RS resource), a second power level (e.g., hypothetical PDSCH EPRE of the CSI-RS antenna ports associated with a CSI-RS resource), an indicator for PDSCH EPRE assumption (e.g., each resource has an associated 1 bit indication, e.g., ‘bit 0’ or ‘bit 1’), and/or a correction factor.

A WTRU may receive a semi-static or a dynamic (e.g., by RRC, MAC-CE, and/or DCI) CSI configuration. The configuration information may include and/or may have associated semi-static or dynamic indications for one or more of a number of CSI-RS resource set(s), a number and indexes of CSI-RS resources in a CSI-RS resource set, and/or a number and indexes of CSI-RS antenna ports or antenna unit(s) in a CSI-RS resource.

The configuration information may include a number of CSI-RS resources set(s). The WTRU may receive a semi-static and/or dynamic indication (e.g., by RRC, MAC-CE, and/or DCI) that indicates the number of configured CSI-RS resource set.

The configuration information may include a number and indexes of CSI-RS resources in a CSI-RS resource set. The WTRU may receive a semi-static and/or dynamic indication (e.g., by RRC, MAC-CE, and/or DCI) that indicates the number of CSI-RS resources in a CSI-RS resource set and the indexes of CSI-RS resources in a CSI-RS resource set.

The configuration information may include a number and indexes of CSI-RS antenna ports or antenna unit(s) in a CSI-RS resource. The WTRU may receive a semi-static or dynamic indication (e.g., by RRC, MAC-CE, and/or DCI) that indicates the number of CSI-RS antenna ports associated with a CSI-RS resource and the indexes of CSI-RS antenna ports that are associated with a CSI-RS resource. Alternatively, or additionally, a fixed rule may be used to indicate the number and/or indexes of antenna ports in a CSI-RS resource. For example, the first CSI-RS resource may be associated with 32 antenna units and/or the indexes of those 32 antenna units may be from 1 up to 32.

One or more of the indicated CSI-RS resource set or one or more of the CSI-RS resources for one or more of the CSI-RS resource set may have implicit or explicit indications for one or more of a first power level associated with a CSI-RS resource, a second power level associated with a CSI-RS resource, an indicator for third power level, and/or a correction factor.

The indicated CSI-RS resource set or one or more of the CSI-RS resources for one or more of the CSI-RS resource set may have implicit or explicit indications for a first power level associated with a CSI-RS resource. The WTRU may receive a semi-static or dynamic implicit or explicit indication (e.g., by RRC, MAC-CE, and/or DCI) that indicates the first power level associated with a CSI-RS resource in a CSI-RS resource set. For example, the WTRU may receive an indication of a first power level for one or more CSI-RS resources in a CSI-RS resource set. For example, the CSI-RS resources may be RRC configured. A first CSI-RS resource may have an associated first power level and/or the first CSI-RS resource may have an associated first power level (e.g., that is fixed and may be known to the WTRU based on the RRC configuration of the CSI-RS resource). When the WTRU receives an indication of the CSI-RS resource for example (e.g., the CSI-RS resource is included in the CSI-RS resource set that will be used for measurement or determination of the CSI report), the WTRU may (e.g., automatically and/or naturally) know the first power level of the CSI-RS resource.

The CSI-RS resource index may be associated with a first power level of the CSI-RS resource. For example when the WTRU receives an indication that indicates the index of the CSI-RS resources, the WTRU may know the first power level associated with the CSI-RS resource. A first channel may have a power level equal to P1 and/or a second channel may have a power level equal to P2. The WTRU may receive an explicit or implicit indication that the first power level of the CSI-RS resource satisfies one or more of

$$\frac{P 1}{first power level} = u 1 and / or \frac{{P}_{2}}{first power level} = u 2 .$$

The WTRU may receive implicit or explicit indications that indicates u1, u2, P1, and/or P2. The WTRU may additionally, or alternatively, receive an implicit or explicit indication of the first and/or second channel. Based on the indication related to the first and/or second channel for example, the WTRU may determine first power level (e.g., when the first channel is indicated) equals

$$\frac{P 1}{u 1}$$

and/or when the second channel is indicated the WTRU may determine that the first power level equals

$$\frac{P 2}{u 2} .$$

The indicated CSI-RS resource set or one or more of the CSI-RS resources for one or more of the CSI-RS resource set may have implicit or explicit indications for a second power level associated with a CSI-RS resource. The WTRU may receive a semi-static or dynamic implicit or explicit indication (e.g., by RRC, MAC-CE, and/or DCI), for example that indicates the second power level associated with a CSI-RS resource in a CSI-RS resource set. For example, the WTRU may receive an indication of a second power level for one or more CSI-RS resources in a CSI-RS resource set. The CSI-RS resources may be RRC configured. A first CSI-RS resource may have an associated second power level and/or the first CSI-RS resource may have an associated second power level, for example that is fixed and/or known to the WTRU based on the RRC configuration of the CSI-RS resource. When the WTRU receives an indication of the CSI-RS resource for example (e.g., when the first CSI-RS resource is included in the CSI-RS resource set that will be used for measurement or determination of the CSI report), the WTRU may (e.g., automatically and/or naturally) know the second power level of the CSI-RS resource. For example, the CSI-RS resource index may be associated with a second power level of the CSI-RS resource. The WTRU may receive an indication that indicates the index of the CSI-RS resources and/or (e.g., therefore) know the second power level associated with the CSI-RS resource.

A first channel may have a power level equal to T1 and/or a second channel may have a power level equal to T2. The WTRU may receive an explicit or implicit indication that the second power level for the CSI-RS resource satisfies one or more of

$$\frac{T 1}{second power level} = U 1 and / or \frac{{T}_{2}}{second power level} = U 2.$$

The WTRU may receive implicit or explicit indications that indicates U1, U2, T1, and/or T2. The WTRU may additionally, or alternatively, receive an implicit or explicit indication of the first and/or second channel. Based on the indication related to the first and/or second channel for example, the WTRU may determine the second power level. For example when the first channel is indicated, the WTRU may determine that the second power level equals

$$\frac{T 1}{U 1} .$$

For example when the second channel is indicated, the WTRU may determine that the second power level for the CSI-RS resource equals

$$\frac{T 2}{U 2} .$$

The indicated CSI-RS resource set or one or more of the CSI-RS resources for one or more of the CSI-RS resource set may have implicit or explicit indications for an indicator for third power level. The WTRU may receive a semi-static or dynamic implicit or explicit indication (e.g., by RRC, MAC-CE, and/or DCI) that indicates information may be used for (e.g., that helps with) determining the third power level associated with a CSI-RS resource in a CSI-RS resource set. For example, the RRC configured CSI-RS resource information element may have a single bit field. The single bit field may be a selection field. The selection field value may be, “bit 0” or “bit 1”. Based on the state value of the selection field bit for example, the WTRU may determine the third power level. Additionally, or alternatively, the WTRU may determine the third power level based on one or more of the first power level, the second power level, and/or the correction factor associated with a CSI-RS resource. For example, the CSI-RS resource set may have two CSI-RS resources. The first CSI-RS resource may have a first power level equal to p₁₁ and/or a second power level equal to p₂₁. The second CSI-RS resource may have a first power level equal to p₁₂ and/or a second power level equal to p₂₂. The state value of the field of the first CSI-RS resource may be 0 and/or the state value of the field of the second CSI-RS resource may be 1. The WTRU may determine (e.g., assume) that the third power level equals the second power level of the second CSI-RS resource combined with the correction factor.

The indicated CSI-RS resource set or one or more of the CSI-RS resources for one or more of the CSI-RS resource set may have implicit or explicit indications for a correction factor. The WTRU may receive a semi-static or dynamic implicit or explicit indication (e.g., by RRC, MAC-CE, and/or DCI) that indicates a correction factor that may be used or combined with other parameters to determine a third power level. For example, the RRC configured CSI-RS resource information element may have a field that includes indication or information related to a correction factor (e.g., a). When the state value of the selection field of a CSI-RS resource is 1 for example, the WTRU may use the second power level and/or the correction factor of that CSI-RS resource to determine a third power level (e.g., the third power level may equal the second power level multiply by the correction factor of the CSI-RS resource).

Systems and methods disclosed may determine a hypothetical DL transmission power level for CSI. A WTRU may receive the CSI-RS resources in the CSI-RS resource set(s). The WTRU may determine a third power level, for example based on the state value of the flag indication(s) and/or the correction factor associated with CSI-RS resources in a CSI-RS resource set. For example, if the flag indication associated with a first CSI-RS resource in a first CSI-RS resource set is “bit 1”, (e.g., then) the WTRU may determine that the third power level equals the second power level associated with the first CSI-RS resource in a first CSI-RS resource set combined with the correction factor associated with the first CSI-RS resource in the first CSI-RS resource set.

Based on the CSI-RS resource configuration (e.g., configuration information) for example, the WTRU may determine to measure the channel after receiving a CSI-RS and/or calculate a CSI that the WTRU includes and reports/transmits on a resource for CSI reporting. The WTRU may use the PDSCH EPRE assumption to determine the power level of a hypothetical PDSCH transmission. In some examples the power level may correspond to the configured second power level. The WTRU may determine the selection between the second and a third power level and/or the third power level.

The WTRU may receive a dynamic indication to select between the second and third power levels, for example on a (e.g., single) resource. The WTRU may dynamically determine a third power level. Additionally, or alternatively, the WTRU may determine the hypothetical DL transmission power level of the CSI as a function of a third power level. The WTRU may receive an indication to trigger a measurement on a CSI-RS resource (e.g., dynamically through an aperiodic or semi-persistent trigger in a DCI, or through a MAC-CE activating/deactivating CSI-RS resource indices). The trigger state may include an (e.g., additional) indication (e.g., a bit). The WTRU may determine the third power level as a function of the (e.g., additional) indication. For example if the indication bit is a 0, the WTRU may determine to use the second power level (e.g., the hypothetical PDSCH EPRE) to determine the CSI. If the indication bit is a 1 for example, the WTRU may determine to use a third power level (e.g., the second power level plus a correction factor) to determine the CSI. Additionally, or alternatively, the indication may be configured to (e.g., further) indicate one or more of (e.g., through more than one bit) a dynamic indication to select between second and third power levels on a pair of resources, and/or a predetermined rule as a function of CSI reporting quantities.

The WTRU may receive a dynamic indication to select between second and third power levels on a pair of resource. If the WTRU is configured with a pair of CSI-RS resources that are triggered together (e.g., Rel-19 for above 32 ports) for example, each CSI-RS resource may be configured with its own second power level which may be different from each other. For the CSI determination that is associated to the pair of CSI-RS resources for example, the indication (e.g., 0 or 1) may be configured such that the WTRU may determine whether the WTRU should use the second power level associated to the first or second CSI-RS resource from the linked pair. Each CSI-RS resource may additionally, or alternatively, be configured with separate correction factors. The indication may be configured so that the WTRU may determine whether the WTRU should use one or more of the first, second, or a combination of the correction factors (e.g., linear combination such as sum, and/or mean, etc.) to determine the third power level.

Alternatively, or additionally, the WTRU may determine the selection of correction factor as a function of a (e.g., default) rule. For example, the WTRU may determine to use the correction factor of the earliest/latest CSI-RS resource transmission in the pair. In some examples the WTRU may determine to use the CSI-RS resource with the lowest/highest resource index in the pair. In other examples the WTRU may determine to use the CSI-RS resource associated with a lowest/highest TRP index (e.g., coresetPoolIndex, and/or resource set index).

The WTRU may determine the selection of power level based on a predetermined rule as a function of CSI reporting quantities. Alternatively, or additionally, for example without a new dynamic indicator, the WTRU may determine the selection of the third power level and/or a correction factor as a function of the CSI reporting quantities associated with the CSI-RS. The WTRU may be configured to report a CSI in a (e.g., single) CSI report associated with multiple CSI-RS resources (e.g., multi-TRP CSI reporting where each CSI resource corresponds to a TRP). For example the WTRU may select the set of TRPs to include in the report and/or may be preconfigured with the set of TRPs. The WTRU may report an aggregated CSI, which for example may be a function of multiple CSI-RS measurements. The WTRU may (e.g., then) be preconfigured with a rule for determining the third power level as a function of the TRP indices. The TRP indices may additionally, or alternatively, be included in the CSI report (e.g., the reporting quantity). For example if the WTRU (e.g., only) reports a CSI for the first CSI-RS, the WTRU may use the second power level as a function. Additionally, or alternatively, if the WTRU reports a CSI for the first and second CSI-RS for example, the WTRU may use the third power level (e.g., which may be a function of the first and/or the second correction factor).

The CSI reporting configuration may explicitly be configured with the association between one or more of power levels, correction factors, and/or reporting quantities (e.g., codebook type, PMI, CQI, RI). For example if configured with codebook Type I reporting, the WTRU may use the second power level. If configured with codebook Type II for example, the WTRU may use the third power level. If configured with (e.g., only) CQI-RI reporting for example, the WTRU may use the third power level with the correction factor.

The WTRU may perform CSI compensation factor. The WTRU may determine a first matrix (e.g., a power or amplitude scaling matrix), for example based on one or more of the first power level associated with each CSI-RS resource in the CSI-RS resource set and/or the determined third power level. The WTRU may determine a CSI based on a hypothetical DL transmission that may have a power level equal to the third power level. Additionally, or alternatively, the WTRU may determine a CSI based on a precoder structure that includes the first matrix. The first matrix may be used to compensate the CSI, for example by scaling the precoder weights associated with one or more CSI-RS antenna ports. The WTRU may report the CSI, for example to the network.

Precoder Structures are disclosed herein. A precoder structure may be in matrix form, for example

$$W = {W}_{1} {W}_{2} ( {W}_{f} ⊗ {W}_{d} ) \qquad ( 7 )$$

where ⊗ may be a Kronecker product operation. Sub-matrices may include one or more of W₁, W₂, W_{f}, and/or W_{d}. W₁ may be a sub-matrix that includes details related to the long-term channel statistics of the wireless channel, for example the wideband channel statistics and/or the spatial domain basis functions for the wideband. W₂ may be a sub-matrix that includes details related to the short-term channel statistics of the wireless channel. For example W₂ may include one or more of co-phasing information to co-phase the antenna units, co-phase panels, combining coefficients or amplitude coefficients, and/or sub-band precoder information, etc. W_{f} may be a sub-matrix that includes details related to compression of the determined CSI, for example frequency-domain compression of the determined combining coefficients or amplitude coefficients. W_{d} may be a sub-matrix that includes details related to compression of the determined CSI, for example temporal-domain and/or Doppler-domain compression of the determined combining coefficients or amplitude coefficients.

Precoders may be based on a precoder structure denoted in matrix form as herein. Additionally, or alternatively, precoders may be based on the absence or presence of sub-matrices described herein. Precoders may include one or more of Rel-15 Type-l and/or Type-II precoders, −16/17 Type-II precoders, Rel-18 Type-II predicted CSI/high Doppler precoders, Rel-18 Type-II CJT precoder, and/or Type-II predicted CSI/high Doppler precoders for CJT. In a Rel-15 Type-I and Type-II precoders for example, the sub-matrices or component precoders W_{f} and W_{d} may be absent. In Rel-16 Type-II precoder, the sub-matrix W_{d} may be absent. In a Rel-18 Type-II predicted CSI precoder, (e.g., all) of the sub-matrices W₁, W₂, W_{f}, and W_{d} may be present. In a Rel-18 Type-II CJT precoder, for N number of TRPs for example, the wideband CSI may be detailed in a W₁ sub-matrix and/or the sub-band CSI for each TRP or selected TRPs may be included in W₂ and/or W_{f}. The sub-matrix W_{d} may be absent in the precoder structure of Rel-18 CJT precoder.

The Type-II precoder structure may be extended to support high Doppler CJT operations for N number of TRPs. Wideband CSI may be detailed in a W₁ sub-matrix. Additionally, or alternatively, the sub-band CSI for each TRP and/or selected TRPs may be included in W₂ and/or W_{f}. A single sub-matrix W_{d} may be present for (e.g., all) the TRPs. For example the same Doppler domain basis may be used for all TRPs. In some examples one sub-matrix may be used for each TRP. In other examples each of the selected TRPs may be used as a Doppler domain basis in the precoder structure.

CSI compensation factor may be based on the precoder. The WTRU may determine a power scaling matrix as herein. The WTRU may use the determined power scaling matrix Wₚ to scale the precoder. The precoder may be a precoder as herein. Additionally, or alternatively, the precoder may be represented in matrix form, for example as

$$W = {W}_{P} {W}_{1} {W}_{2} ( {W}_{f} ⊗ {W}_{d} ) . \qquad ( 8 )$$

Details related to determining the power scaling matrix Wₚ are disclosed herein. One or more of the following may be used by the gNB and/or the WTRU to determine the power scaling matrix Wₚ. A WTRU may be semi-statically or dynamically (e.g., by RRC, MAC-CE, and/or DCI) configured with a codebook of power scaling matrices. The codebook of power scaling matrices may include one or more power scaling matrices (e.g., one or more Wₚ matrices). A matrix (e.g., each Wₚ matrix) of the codebook of Wₚ matrices may have an associated index and/or an associated codepoint that is known to both the WTRU and the gNB. From the configured codebook for example, the WTRU may determine (e.g., select) a power scaling matrix. The WTRU may determine (e.g., select) the power scaling matrix that one or more of maximizes channel capacity, (e.g., maximizes) signal to noise ratio (SNR), and/or minimize interference.

The WTRU may perform a search through one or more power scaling matrices in the codebook, for example to find the best choice of Wₚ. However, a search may be computationally expensive. Systems and methods are disclosed herein which may reduce a WTRU search complexity for selecting and/or determining a Wₚ matrix. The WTRU may be semi-statically or dynamically configured with a codebook subset restriction (CBSR), for example associated to the codebook of power scaling matrices. The CBSR may restrict the WTRU from selecting one or more power scaling matrices Wₚ. For example, the codebook may have four Wₚ matrices. The WTRU may receive a bitmap (e.g., [1 0 1 1]). A (e.g., each) bit may be associated with a Wₚ matrix. Based on the example bitmap for example, the WTRU may be restricted to select the second Wₚ matrix in the codebook. Additionally, or alternatively, the WTRU may be restricted to select the first, third, and/or fourth Wₚ matrix.

The WTRU may receive downlink control information (DCI), for example from a network. The DCI may include an indication that indicates a maximum power or amplitude level and/or a minimum power level of one or more diagonal entries of the Wₚ matrix. The WTRU may only select Wₚ matrices whose indicated diagonal entries are less than the indicated minimum, greater than the indicated maximum, or in between the indicated minimum and indicated maximum value. For example, the WTRU may receive an indication, for example that indicates a minimum value of 0.4 and/or a maximum value of 0.8 for one or more diagonal entries (e.g., for the first diagonal entry of the Wₚ matrix). The WTRU may select a Wₚ matrix whose first diagonal value is less than 0.4, or alternatively whose first diagonal value is greater than 0.4. In some examples the WTRU may select a Wₚ matrix whose first diagonal value is less than 0.8, or alternatively whose first diagonal value is greater than 0.8. In other examples the WTRU may select a Wₚ matrix whose first diagonal value is within the range of 0.4 and 0.8. In other examples the WTRU may select a Wₚ matrix whose first diagonal value is outside of the range of 0.4 and 0.8.

The number of Wₚ matrices in the codebook of Wₚ matrices and the diagonal entries of each of the Wₚ matrix in the codebook of Wₚ matrices may be known to (e.g., both) the WTRU and/or the network (e.g., gNB). The WTRU may report an index of a selected Wₚ matrix, for example based on one or more of a codebook of matrices and/or a scheduling configuration.

The codebook of Wₚ matrices may have Q=8 Wₚ matrices, out of which for example Q₁=5 Wₚ may be restricted Wₚ matrices and the remaining Q₂=3 may be non-restricted Wₚ matrices. The WTRU may select and/or report one of the Q₂=3 Wₚ matrices. The WTRU may not select and/or report any of the Q₁=5 Wₚ matrices. The WTRU may send an indicator to indicate the selected Wₚ matrix. The indicator may be an indicator with [log₂ Q] number of bits, (e.g., with 3 bits when Q=8). In some examples the indicator may be an indicator with [log₂ Q₂] number of bits. For example when Q₂ out of Q Wₚ matrices are allowed for selection, Q₁ out of Q matrices may be restricted for selection and/or the total Wₚ matrices in the codebook of Wₚ matrices, equals Q=Q₁+Q₂. In other examples the indicator may be an indicator with Q bits (e.g., [1 0 0 0 0 0 0 0]) for example when the first Wₚ matrix may be allowed for selection and/or the WTRU selects the first Wₚ matrix in the codebook of Wₚ matrices. Additionally, or alternatively, the indicator may be an indicator with [0 0 0 0 1 0 0 0] when the sixth Wₚ matrix may be allowed for selection and/or the WTRU selects the sixth Wₚ matrix in the codebook of Wₚ matrices. In other examples the indicator may be an indicator with Q₂ bits (e.g., [0 1 0]) when the third, sixth, and seventh Wₚ matrices may be allowed for selection and/or the WTRU selects the sixth Wₚ matrix in the codebook of Wₚ matrices. Additionally, or alternatively, the indicator may be an indicator with [0 0 1] when the seventh Wₚ matrix is selected. The WTRU may receive configuration information, for example a scheduling configuration (e.g., a DCI). The DCI may include (e.g., only) some of power scaling matrices in the codebook. For example, the WTRU may update the codebook based on the new power scaling matrices to reduce the computational cost.

The WTRU may select the power scaling matrix from a codebook of matrices. The WTRU may receive one or more of a semi-static, dynamic explicit, and/or implicit indication, for example indicating which one of the power scaling matrices in a configured codebook of power scaling matrices may the WTRU use. For example, the WTRU may receive a DCI that includes an indication indicating to the WTRU which of the power scaling matrix to use. For example, the CSI-RS resource information element may have an associated indication that may indicate which of the configured Wₚ matrix to use for determination of the CSI report. For example one or more of the configured CSI-RS resources may have an associated indication that indicates to the index of a Wₚ matrix in a codebook of Wₚ matrices. When one or more CSI-RS resources are configured for example, the WTRU may select a CSI-RS resource for determination of a Wₚ matrix based on the reference resource as herein.

A first and/or a second power level of one or more CSI-RS resources in the configured set of CSI-RS resources may be associated with a power scaling matrix. For example the powerControlOffset and/or powerControlOffsetss values of one or more CSI-RS resources may be associated with a Wₚ matrix. The WTRU may determine a power scaling matrix, for example based on one or more of the configured powerControlOffset and powerControlOffsetss values for a CSI-RS resource, and/or the selected CSI-RS resource.

The first power level of the selected CSI-RS resource may be associated with one of the Wₚ matrices for each CSI-RS resource. The WTRU may report the index of the selected Wₚ matrix to the network (e.g., gNB). The WTRU may report W, for example as given in Eq. 1, for each CSI resource (e.g., if the WTRU reports CSI based on each resource/balanced power setting). In some examples there may be no imbalanced power setting for CSI reporting based on each resource.

The WTRU may prioritize the CSI resources. The WTRU may report the index of selected Wₚ matrix to the network (e.g., gNB). Additionally, or alternatively, the WTRU may report W, for example as given in Eq. 7 (e.g., only for the CSI resource associated with the priority). If the number of CSI resources are more than two for example, the WTRU may report the index of selected Wₚ matrix to the network (e.g., gNB) and/or report W (e.g., as given in Eq. 7 for the CSI resources associated with the first and second priorities).

The indication may be an explicit indication. For example the explicit indication may include the EPRE of the CSI-RS resources (e.g., the offset values). Additionally, or alternatively, the explicit indication may include an indication that the third power level may be associated with one of the Wₚ matrices for each CSI-RS resource.

The WTRU may select an indication of a Wₚ matrix from the codebook. The WTRU may select a Wₚ matrix and/or calculate the precoding matrix W, for example as given in Eq. 8 for a (e.g., each) resource. The WTRU (e.g., therefore) may not report the index of Wₚ. The WTRU may explicitly report the selected Wₚ to the network (e.g., gNB), for example with reported W. The WTRU may select a Wₚ matrix and/or jointly calculate the precoding matrix W for all resources. The WTRU may (e.g., therefore) not report the index of Wₚ. The WTRU may explicitly report Wₚ to the network (e.g., gNB), for example with reported W for all CSI resources.

Power scaling matrix selection may be based on one or more criterion, for example performance criterion. The WTRU may receive a semi-static or dynamic indication that indicates and/or configures one or more criterion for determination or selection of a Wₚ matrix. For example, the WTRU may receive an indication that indicates one or more criterion. The indication may be received through DCI. The one or more criterion may include maximize SINR, minimize interference, maximize channel capacity, and/or minimize energy consumption.

The WTRU may select a Wₚ matrix based on the configured criteria by the network (e.g., gNB). The WTRU may select one or more of the criterion and/or select a Wₚ matrix such that the criteria is satisfied or is met. For example, the WTRU may select one or more criterion (e.g., minimizing interference and/or (e.g., then accordingly) select a Wₚ matrix such that energy consumption is reduced and/or energy efficiency is enhanced). In the associated CSI report for example, the WTRU may send a first indicator. The first indicator may indicate one or more criterion used for determination of the CSI report. The WTRU may send a second indicator, for example that indicates the index of the power scaling matrix in the codebook of power scaling matrices that was by the WTRU to determine the CSI report.

The WTRU may select one of the Wₚ matrices for CSI determination and/or prediction based on one or more of a SINR value, a capacity value, an interference value, an offset value, and/or a threshold value. The WTRU may determine one or more of a SINR value, a capacity value, and/or an interference value based on measurements performed on one or more CIS-RS antenna ports associated with one or more CSI-RS resources in the CSI-RS resource set. The WTRU may (e.g., then) select or determine a Wₚ matrix such that the aggregate SINR value (e.g., the sum of the SINRs of one or more of the selected CSI-RS resources), the aggregated capacity value (e.g., the sum of the capacities of one or more of the selected CSI-RS resources), and/or interference value (e.g., the sum of the interference of one or more of the selected CSI-RS resources) is maximized or is minimized.

The WTRU may be configured with one or more offset value and/or threshold value for the first power level and/or the second power level. The WTRU may select one of the Wₚ matrices based on one or more of the (e.g., actual) value(s) of the first and/or the second power levels, the offset value, and/or the threshold value. Power level as herein may mean a first power level and/or a second power level. The WTRU may be configured with two power offset values and/or threshold values such as powerₜₕ₁ and powerₜₕ₂. One or more Wₚ matrices may be pre-defined (e.g., defined as fixed) and/or configured based on the power level and the offset value and/or threshold value. The WTRU may select a power scaling matrix based on the configured Wₚ matrices and/or based on the threshold value and/or offset value.

If power level<powerₜₕ₁ for example, the WTRU may select a Wₚ matric from a first pre-designed subset of Wₚ matrices which may be configured to the WTRU semi-statically or dynamically. If powerₜₕ₁<power level<powerₜₕ₂ for example, the WTRU may select a Wₚ matric from a second pre-designed subset of Wₚ matrices. The second pre-designed subset of Wₚ matrices may be different than the first pre-designed subset of Wₚ matrices and/or may be configured for the WTRU semi-statically or dynamically. If power>powerₜₕ₂ for example, the WTRU may select a Wₚ matric from a third pre-designed subset of Wₚ matrices which may be semi-statically or dynamically configured/indicated.

Additionally, or alternatively, the WTRU may be configured with two thresholds for the ratio of

$$\frac{B 1}{B 2} and \frac{B 2}{B 1} as {( \frac{B 1}{B 2} )}_{t h} and {( \frac{B 2}{B 1} )}_{t h} ,$$

respectively and/or may design a Wₚ matrix based on these thresholds. For example if B1/B2>(B1/B2)ₜₕ and B2/B1>(B2/B1)ₜₕ, the WTRU may select diagonal entries associated with CSI-RS resource 1 equals

$$\frac{B 2}{B 1}$$

(e.g., regardless of determination of the third power level). If

$$\frac{B 2}{B 1} > {( \frac{B 2}{B 1} )}_{t h} and \frac{B 1}{B 2} < {( \frac{B 1}{B 2} )}_{t h}$$

for example, the WTRU may select the diagonal entries associated with CSI-RS resource 2 equals B1/B2 (e.g., regardless of determination of the third power level).

$$If \frac{B 1}{B 2} < {( \frac{B 1}{B 2} )}_{t h} and \frac{B 2}{B 1} < {( \frac{B 2}{B 1} )}_{t h}$$

for example, the WTRU may be configured with a set of pre-defined values for diagonal entries of Wₚ matrix.

If

$$\frac{B 1}{B 2} > {( \frac{B 1}{B 2} )}_{t h} and \frac{B 2}{B 1} > {( \frac{B 2}{B 1} )}_{t h}$$

for example, the WTRU may be configured with a set of pre-defined values for diagonal entries of Wₚ matrix.

Systems and methods for precoder normalization are disclosed herein. Wₚ may include (e.g., be designed with) a normalization coefficient (e.g., a Wₚ), for example to normalize the precoder W in Eq. 7 and/or in Eq. 8. The normalized coefficient may be calculated such that W becomes normalized. For example the normalized coefficient may be calculated such that tr {W W^{H}}=1 is satisfied, where tr may indicate the trace operation. Alternatively, or additionally tr {αWₚW₁Wᵣ(W₂⊗W_{d})(αWₚW₁W_{f}(W₂⊗W_{d}))^{H}}=1. The normalization coefficient may be calculated as

$$α = \sqrt{\frac{1}{tr \{ {W}_{P} {W}_{1} {W}_{f} ( {W}_{2} ⊗ {W}_{d} ) {( {W}_{p} {W}_{1} {W}_{f} ( {W}_{2} ⊗ {W}_{d} ) )}^{H} \}}} .$$

Modes of a precoder are disclosed herein, for example different modes. The precoder structure of Equation (7) may be referred to as precoder mode-1. The precoder structure of Equation (8) may be referred to as precoder mode-2.

The WTRU may determine that the CSI-RS resources are configured with a balanced or imbalanced power setting. The WTRU may receive a configuration (e.g., configuration information) of a codebook and/or a precoder type (e.g., as described herein), for example when the CSI-RS resources are configured with a balanced power setting. For example, the configured codebook type may be a Rel-16 enhanced Type-II codebook. The WTRU may use precoder mode-1 for the configured codebook type to determines a CSI, for example when the CSI-RS resources are configured with a balanced power setting. For example, the WTRU may use a precoder mode-1 with a precoder structure W=W₁W₂W_{f} to determine a CSI (e.g., to determine a PMI).

The WTRU may receive a configuration (e.g., configuration information) of a codebook or precoder type (e.g., as described herein), for example when the CSI-RS resources are configured with an imbalanced power setting. The WTRU may use precoder mode-2 for the configured codebook type to determine a CSI, for example when the CSI-RS resources are configured with imbalanced power setting. For example, the WTRU may use a precoder mode-2 with a precoder structure W=Wₚ W₁W₂W_{f} to determine a CSI (e.g., to determine a PMI). The configured power setting (e.g., the configured balanced power setting or imbalanced power setting) may be used by the WTRU and/or interpreted by the WTRU as an implicit indication of the precoder mode to use. For example precoder mode-1 may be used for balanced power setting and/or precoder mode-2 may be used for imbalanced power setting.

The sub-matrix, sub precoder, component precoder, and/or the power scaling matrix Wₚ may be different between precoder mode-1 and precoder mode-2. The absence or presence of the power scaling matrix may determine a precoder mode. In precoder mode-1 for example, the power scaling matrix may be present (e.g., the codebook structure in Equation (8) may be used when balanced power setting is configured but the diagonal entries of the power scaling matrix may all be equal to ones). In precoder mode-2 for example, the diagonal entries of the power scaling matrix may be as discussed as herein. Alternatively, or additionally, in precoder mode-1 for example, the power scaling matrix may be fully absent (e.g., as in the example structure of Equation (7).

Aspects of the power scaling matrix may be implemented. The power scaling matrix may be implemented by the WTRU, for example when determining the CSI. The power scaling matrix may be implemented by the network (e.g., gNB), for example when the network uses the precoder to generate a beam for data transmission to the WTRU. The power scaling matrix may be implemented in terms of matrix multiplications, for example as in Equation 8 and/or based on some scaler multiplication across one or more antenna unit(s).

The CSI compensation factor at the precoder level may be performed at the baseband level, for example using matrix multiplication and/or by multiplying the data symbol at the baseband level by suitable scaling factors (e.g., by the diagonal entries of the power scaling matrix). The procedures for scaling the energy, amplitude, and/or power level of one or more data transmission symbols or antenna unit(s) disclosed herein may be in the form of matrix/matrices multiplications or matrices/matrices manipulation. Scaling may be performed by scaling one or more of the amplitude, power, and/or energy level of the transmission symbols, for example at the base-band level. Additionally, or alternatively, scaling one or more of the amplitude, power, and/or energy level may be performed at one or more antenna unit(s) at the pass-band level.

CSI compensation factor may be based on a channel matrix. A WTRU may be configured with more than one CSI resources. The one or more of the configured resources in the set may be configured with a different power setting than a first resource, for example due to one or more of being mapped to different transmission slots, and/or different EPRE settings, etc.

CSI resources (e.g., all CSI resources) may be configured within a (e.g., the same) resource set. Once a WTRU is configured to report CSI based on the aggregated CSI ports of the configured CSI resources for example, a WTRU may perform measurement on configured ports in each received CSI resource. The WTRU may (e.g., then) estimate an overall CSI, for example based on the aggregated ports. When configured CSI resources are set with a different power setting for example, the measured power across the configured CSI resources may not be balanced, which may for example lead to a distorted CSI estimate. For example, when CSI resources are configured with two power settings, the directly measured channel may be represented as H_{measured}=[H₁ aH₂], where H₁ and H₂ represent the channel corresponding to the first and second CSI resources, respectively. a may represent the ratio of the transmitted power between the first and second CSI resource. For example, a=powerControlOffset2/powerControlOffset 1, where powerControlOffsetx may be the power offset resulted from the configuration (e.g., from configured EPRE values).

When the received CSI resources are configured with different powers for example, a WTRU may determine a reference CSI resource. The WTRU may determine the CSI resource as the reference CSI resource may be fixed (e.g., the first, the second, the last, etc.). The WTRU may determine the CSI resource based on the reference CSI resource which may be the strongest, the weakest, etc. In another example, the reference CSI resource may be configured and/or indicated. For example, the reference CSI may be configured as part of CSI configuration information (e.g., by a flag, or association to an ID (resource ID, trigger list ID, etc.).

When the received CSI resources are configured with different powers for example, a WTRU may determine the power difference between the reference resource and the other resources. When the received CSI resources are configured with different powers for example, a WTRU may scale the estimated channel based on the received CSI resources to balance the power. The WTRU may scale the estimated channel based on resources including the reference resource to balance the power. For example, a WTRU may derive an estimate of the actual aggregated channel by compensating H₁ by k₁ and/or aH₂ by k₂ to yield, H_{Actual}=k[H₁ H₂], where k may be determined based on one or more criterion (e.g., maximizing the SNR of the estimated channel samples). The WTRU may scale the estimated channel based on resources other than the reference resource to balance the power. For example, a WTRU may derive an estimate of the actual aggregated channel by compensating by aH₂ by 1/a to yield, H_{Actual}=[H₁ H₂].

When the received CSI resources are configured with different powers for example, a WTRU may report the CSI. The WTRU may estimate and/or report the CSI (e.g., LI, RI, CQI, and/or PMI, etc.), based on the estimated actual aggregated channel. The WTRU may additionally, or alternatively, report the scaling factors used for the determination of the actual channel (e.g., k).

The WTRU may estimate an initial CSI (e.g., LI, RI, CQI, and/or PMI, etc.), based on the estimated (e.g., actual) aggregated channel. The WTRU may adjust the estimated CSI (e.g., CQI) based the compensation factors as herein. The WTRU may (e.g., then) report the CSI. The WTRU may report the derived CSI. The WTRU may complete CSI measurement and/or reporting (e.g., of CSI).

Systems and methods may reduce energy consumption of CSI-RS. The systems and methods disclosed herein may be used to reduce the energy consumption or the power of CSI-RS resources. For example, the network (e.g., gNB) may (e.g., intentionally) transmit one or more CSI-RS resources at different power levels to save energy. Additionally, or alternatively, the WTRU may utilize one or more of the systems and methods disclosed herein to determine a CSI based on the CSI-RS resources. For example, the network (e.g., gNB) may transmit a first CSI-RS resource with a required power level and/or a second CSI-S resource with a lower power level to save energy. The WTRU may determine a CSI based on the CSI-RS resources and/or based on systems and methods disclosed herein. For example the WTRU may select a reference resource and/or (e.g., then) compensate CSI as the CSI-RS resources may be at different power levels.

1. A wireless transmit/receive unit (WTRU) comprising:
a processor, the processor configured to:
receive configuration information associated with one or more channel state information reference signals (CSI-RSs), the configuration information comprising a first indication of a first transmit power level and a second indication of a second transmit power level for each of the one or more CSI-RSs;
determine whether the second transmit power level is the same for each of the one or more CSI-RSs;
determine whether to apply a compensation factor to determine CSI; and
send an indication of determined CSI to a network.

2. The WTRU of claim 1, wherein the processor is configured to determine a third transmit power level, and wherein the processor configured to determine whether to apply the compensation factor to determine CSI comprises the processor being configured to determine the compensation factor to determine CSI based on the third transmit power level.

3. The WTRU of claim 2, wherein the processor is configured to receive a third indication of a correction factor and a selection indicator, and wherein the processor configured to determine the third transmit power level comprises the processor being configured to determine the third transmit power level based on the correction factor and the selection indicator.

4. The WTRU of claim 3, wherein the processor configured to determine the third transmit power level based on the correction factor and the selection indicator comprises the processor being configured to determine that the third transmit power level equals the second transmit power level plus the correction factor when the selection indicator indicates the second transmit power level.

5. The WTRU of claim 2, wherein the processor is configured to determine the CSI based on a hypothetical downlink transmit power level equal to the third transmit power level.

6. The WTRU of claim 1, wherein the processor is configured to determine whether the first transmit power level is the same for each of the one or more CSI RS based on a determination that the second transmit power level is the same for each of the one or more CSI RS.

7. The WTRU of claim 1, wherein the processor configured to determine whether to apply a compensation factor to determine CSI comprises the processor being configured to determine to not apply the compensation factor based on a determination that the first transmit power level is the same for each of the one or more CSI RS.

8. The WTRU of claim 1, wherein the first transmit power level comprises an energy per resource element (EPRE) associated with a CSI-RS resource (RE) and the second transmit power level comprises a hypothetical physical downlink shared channel (PDSCH) (EPRE) associated with the CSI-RS resource.

9. The WTRU of claim 1, wherein the processor is configured to determine a matrix, and wherein the processor configured to determine whether to apply a compensation factor to determine CSI comprises the processor being configured to determine compensation factor to determine CSI based on the matrix.

10. The WTRU of claim 9, wherein the processor configured to determine whether to apply the compensation factor to determine CSI comprises the processor being configured to determine the compensation factor to determine CSI based on the first transmit power level.

11. A method implemented by a wireless transmit/receive unit (WTRU), the method comprising:
receiving configuration information associated with one or more channel state information reference signals (CSI-RSs), the configuration information comprising a first indication of a first transmit power level and a second indication of a second transmit power level for each of the one or more CSI-RSs;
determining whether the second transmit power level is the same for each of the one or more CSI-RSS;
determining whether to apply a compensation factor to determine CSI; and
sending an indication of determined CSI to a network.

12. The method of claim 11, comprising determining a third transmit power level, wherein determining whether to apply the compensation factor to determine CSI comprises determining the compensation factor to determine CSI based on the third transmit power level.

13. The method of claim 12, comprising receiving a third indication of a correction factor and a selection indicator, wherein determining the third transmit power level comprises determining the third transmit power level based on the correction factor and the selection indicator.

14. The method of claim 13, wherein determining the third transmit power level based on the correction factor and the selection indicator comprises determining that the third transmit power level equals the second transmit power level plus the correction factor when the selection indicator indicates the second transmit power level.

15. The method of claim 12, comprising determining the CSI based on a hypothetical downlink transmit power level equal to the third transmit power level.

16. The method of claim 11, comprising determining whether the first transmit power level is the same for each of the one or more CSI RS based on a determination that the second transmit power level is the same for each of the one or more CSI RS.

17. The method of claim 11, wherein determining whether to apply a compensation factor to determine CSI comprises determining to not apply the compensation factor based on a determination that the first transmit power level is the same for each of the one or more CSI RS.

18. The method of claim 11, wherein the first transmit power level comprises an energy per resource element (EPRE) associated with a CSI-RS resource (RE) and the second transmit power level comprises a hypothetical physical downlink shared channel (PDSCH) (EPRE) associated with the CSI-RS resource.

19. A wireless transmit/receive unit (WTRU) comprising a processor configured to:
receive configuration information associated with a plurality of sets of channel state information reference signals (CSI-RSs), the configuration information comprising a first indication of a first transmit power level and a second indication of a second transmit power level for each of the one or more sets of CSI-RSs;
determine whether a third power level for at least one of the sets of the CSI-RSs based on whether the second transmit power level is the same for each of the sets of CSI-RSs;
determine whether to apply a compensation factor for the at least one of the sets of CSI-RSs based on whether the first transmit power level is the same for each of the sets of CSI-RSs;
determine a CSI value based on the at least one set of the sets of CSI-RSs and one or more of the third power level or the compensation factor; and
report the CSI to a network.

20. The WTRU of claim 19, wherein the first power level corresponds to an energy per resource element (EPRE), the second power level corresponds to a hypothetical physical downlink shared channel (PDSCH) EPRE, the third power level corresponds to the second power level with an applied correction factor, and the compensation factor corresponds to a scaling factor associated with a precoder or a channel estimate.
